(19) United States
(12) Patent Application Publication
(10) Pub. No.: US 2018/0137638 A1
(43) Pub. Date: May 17, 2018

(54) PROCESSING DEVICE, IMAGE CAPTURE DEVICE, AND AUTOMATIC CONTROL SYSTEM

(71) Applicant: Kabushiki Kaisha Toshiba, Tokyo (JP)

(72) Inventors: Yasunori TAGUCHI, Kawasaki Kanagawa (JP); Yusuke Moriuchi, Tokyo (JP); Nao Mishima, Tokyo (JP); Takeshi Mita, Yokohama (JP)

(73) Assignee: Kabushiki Kaisha Toshiba, Tokyo (JP)

(21) Appl. No.: 15/693,442

(22) Filed: Aug. 31, 2017

(30) Foreign Application Priority Data
Nov. 11, 2016 (JP) 2016-220648

(51) Int. Cl. G06T 7/55; H04N 5/232; H04N 9/083; E05F 15/73

(52) U.S. Cl. CPC G06T 7/55; H04N 5/23229; H04N 5/23296; H04N 9/083; E05Y 2900/531; E05F 15/73; E05F 2015/767; E05Y 2900/132; H04N 5/23264

(57) ABSTRACT

According to one embodiment, a processing device includes a memory and a circuit coupled with the memory. The circuit acquires a first image of a first color component and a second image of a second color component. The first image has a non-point-symmetric blur function and captures a first object. The second image has a point-symmetric blur function and captures the first object. The circuit determines whether the first object is on a near side of a first position or on a deep side of the first position when viewed from a capture position based on the first image and the second image.

### CROSS-REFERENCE TO RELATED APPLICATIONS

This application is based upon and claims the benefit of priority from Japanese Patent Application No. 2016-220648, filed Nov. 11, 2016, the entire contents of which are incorporated herein by reference.

### FIELD

Embodiments described herein relate generally to a processing device, an linage capture device, and an automatic control system.

### BACKGROUND

In recent years, a computational photography technology is received a lot of attraction. In the technology, changing an image capture process and encoding distance information into a captured image achieves acquiring the image and the distance information at the same time. By using the technology, a distance to the object can be obtained using the captured image.

### BRIEF DESCRIPTION OF THE DRAWINGS

FIG. 1 is a block diagram illustrating an example of a hardware configuration of an image capture device according to an embodiment.

FIG. 2 is a diagram illustrating an example of a configuration of a filter provided in the image capture device of the embodiment.

FIG. 3 is a diagram illustrating an example of a transmittance characteristic of the filter of FIG. 2.

FIG. 4 is a diagram for describing a change of light rays and a blur shape caused by a color-filtered aperture in which the filter of FIG. 2 is disposed.

FIG. 5 is a diagram for describing an example of a method of calculating a distance to an object by using blur on an image captured by the image capture device of the embodiment.

FIG. 6 is a diagram for describing an example of a method of determining whether the object is on a deep side or on a near side from a focus distance using the blur on the image captured by the image capture device of the embodiment.

FIG. 7 is a block diagram illustrating an example of a functional configuration of the image capture device of the embodiment.

FIG. 8 is a diagram for describing a first example in which the image capture device of the embodiment determines that the object is on the deep side from the focus distance.

FIG. 9 is a diagram for describing a second example in which the image capture device of the embodiment determines that the object is on the deep side from the focus distance.

FIG. 10 is a diagram for describing a first example in which the image capture device of the embodiment determines that the object is on the near side from the focus distance.

FIG. 11 is a diagram for describing a second example in which the image capture device of the embodiment determines that the object is on the near side from the focus distance.

FIG. 12 is a diagram for describing a third example in which the image capture device of the embodiment determines that the object is on the deep side from the focus distance.

FIG. 13 is a diagram for describing a fourth example in which the image capture device of the embodiment determines that the object is on the deep side from the focus distance.

FIG. 14 is a diagram for describing a third example in which the image capture device of the embodiment determines that the object is on the near side from the focus distance.

FIG. 15 is a diagram for describing a fourth example in which the image capture device of the embodiment determines that the object is on the near side from the focus distance.

FIG. 16 is a diagram for describing a blur correction filter to correct the blur on an image captured by the image capture device of the embodiment.

FIG. 17 is a flowchart illustrating an example of the procedure of a determination process executed by the image capture device of the embodiment.

FIG. 18 is a flowchart illustrating an example of another procedure of the determination process executed by the image capture device of the embodiment.

FIG. 19 is a block diagram illustrating an example of a functional configuration of an automatic door system that includes the image capture device of the embodiment.

FIG. 20 is a diagram illustrating an example in which the control is performed in a state where an automatic door is opened when the automatic door system of FIG. 19 determines that the object is on the near side from a reference distance.

FIG. 21 is a diagram illustrating an example in which the control is performed in a state where the automatic door is closed when the automatic door system of FIG. 19 determines that the object is on the deep side from the reference distance.

FIG. 22 is a flowchart illustrating an example of the procedure of an automatic door control process executed by the automatic door system of FIG. 19.

FIG. 23 is a perspective view illustrating an example of an external appearance of an automobile that includes the image capture device of the embodiment.

FIG. 24 is a block diagram illustrating a functional configuration of a moving object that includes the image capture device of the embodiment.

FIG. 25 is a perspective view illustrating an example of an external appearance of the moving object of FIG. 24.

FIG. 26 is a block diagram illustrating an example of a functional configuration of a monitor system that includes the image capture device of the embodiment.

FIG. 27 is a diagram for describing an example of a monitor target of the monitor system of FIG. 26.

### DETAILED DESCRIPTION

Various embodiments will be described hereinafter with reference to the accompanying drawings.

In general, according to one embodiment, a processing device includes a memory and a circuit coupled with the memory. The circuit acquires a first image of a first color component and a second image of a second color component. The first image has a non-point-symmetric blur function (point spread function) and captures a first object. The second image has a point-symmetric blur function and captures the first object. The circuit determines whether the first object is on a near side of a first position or on a deep side of the first position when viewed from a capture position based on the first image and the second image.

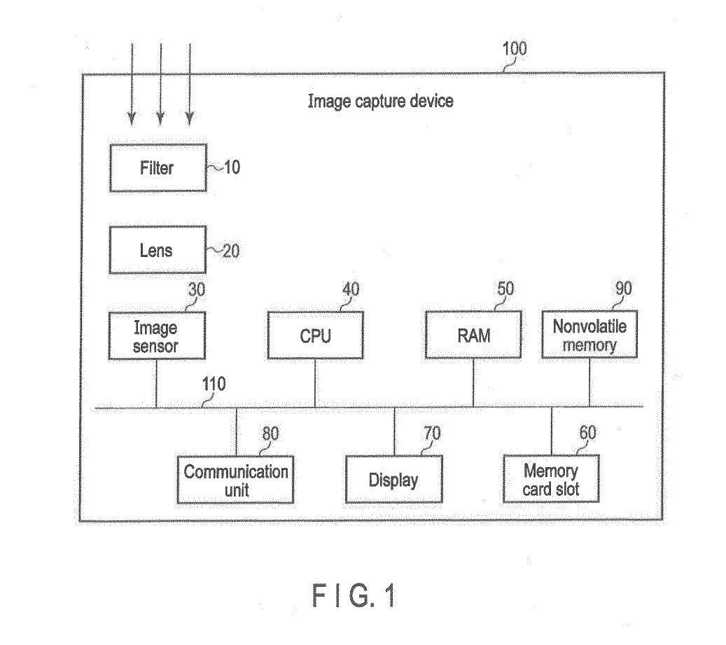

First, a configuration of an image capture device according to an embodiment will be described with reference to FIG. 1. An image capture device 100 has a function of acquiring an image, and processing the acquired image. The image capture device 100 may be realized as, for example, a camera, a portable information terminal such as a portable telephone, a smartphone, or a personal digital assistant (PDA) having a camera function, a personal computer having a camera function, or a video recording device such as a drive recorder.

In recent years, a technology of calculating a distance to an object on an image by using the image is received a lot of attraction. However, a process of calculating the distance to the object causes a high calculation cost, and a high-speed calculation may be not easy. In addition, as well as the calculation of the distance to the object, there are some cases in which it is important to determine whether the object is on a near side or a deep side from a reference position depending on applications. Therefore, there is a need to realize a new function in order to determine a position of the object with respect to the reference position at a high speed.

As illustrated in FIG. 1, the image capture device 100 includes, for example, a filter 10, a lens 20, an image sensor 30, an image processing unit, and a storage unit. The image processing unit is, for example, configured by a circuit such as a CPU 40. A RAM 50 and a nonvolatile memory 90 constitute the storage unit. The image capture device 100 may further include a memory card slot 60, a display 70, and a communication unit 80. For example, a bus 110 can connect the image sensor 30, the CPU 40, the RAM 50, the memory card slot 60, the display 70, the communication unit 80, and the nonvolatile memory 90 each other.

The image sensor 30 receives light passing through the filter 10 and the lens 20, and converts (photoelectrically converts) the received light into an electric signal to generate an image. The image sensor 30 generates an image including pixels. Each of the pixels contains at least one color component. As the image sensor 30, for example, a charge coupled device (CCD) or a complementary metal oxide semiconductor (CMOS) is used. The image sensor 30 includes, for example, imaging elements which receive a red (R) light, imaging elements which receive a green (G) light, and imaging elements which receive a blue (B) light. Each imaging element receives the light of the corresponding wavelength band, and converts the received light into an electric signal. A/D converting the electric signal can generate a color image. In the following, an R component, a G component, and a B component of the image may be referred to as an R image, a G image, and a B image, respectively. Further, the R image, the G image, and the B image can be generated using the electric signals of the red, green, and blue imaging elements, respectively.

The CPU 40 controls various components in the image capture device 100. The CPU 40 executes various programs which are loaded from the nonvolatile memory 30 that is used as a storage device to the RAM 50. In the nonvolatile memory 90, an image generated by the image sensor 30 and a processing result of the image may be stored.

In the memory card slot 60, various portable storage mediums such as an SD memory card and an SDHC memory card may be inserted. When inserting the storage medium into the memory card slot 60, data may be written to and read from the storage medium. The data includes, for example, image data and distance data.

The display 70 is, for example, a liquid crystal display (LCD). The display 70 displays a screen image based on a display signal generated by the CPU 40. Further, the display 70 may be a touch screen display. In this case, for example, a touch panel is disposed on the upper surface of the LCD. The touch panel is a capacitive pointing device for inputting on the screen of the LCD. The touch panel detects a contact position on the screen that is touched by a finger and a movement of the contact position.

The communication unit 80 is an interface device that performs a wired communication or a wireless communication. The communication unit 80 includes a transmitter transmitting a signal in a wired or wireless manner, and a receiver receiving a signal in a wired or wireless manner.

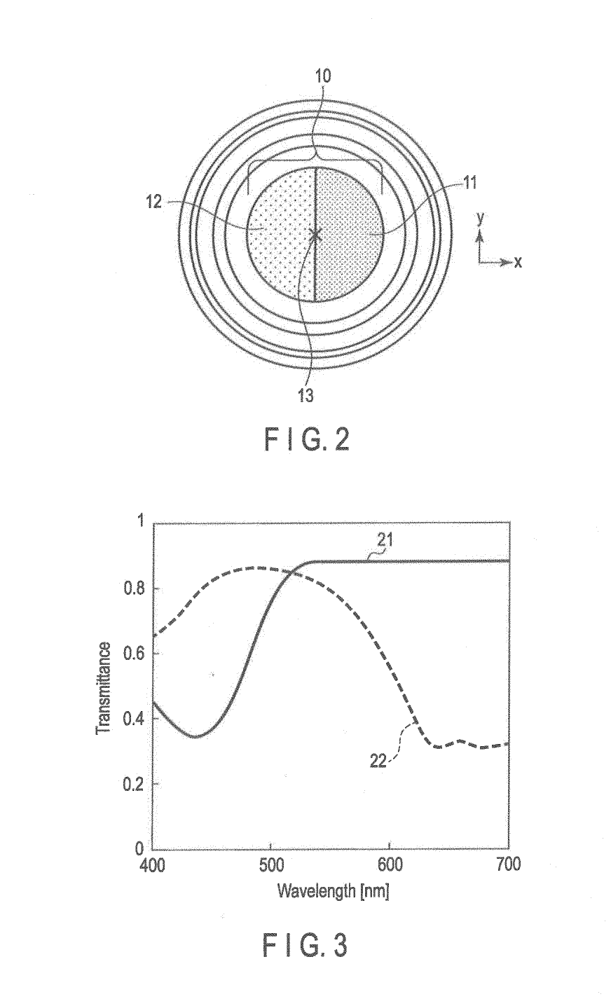

FIG. 2 illustrates a configuration of the filter 10. Two color filter regions such as a first filter region 11 and a second filter region 12 constitute the filter 10. The center of the filter 10 matches wish an optical center 13 (optical axis) of the image capture device 100. The first filter region 11 and the second filter region 12 each have a non-point-symmetric shape with respect to the optical center 13. For example, the first filter region 11 does not overlap with the second filter region 12, and these two filter regions 11 and 12 form the entire region of the filter 10. In the example illustrated in FIG. 2, the first filter region 11 and the second filter region 12 have a semicircular shape in which the circular filter 10 is divided by a segment passing through the optical center 13. The first filter region 11 is, for example, a yellow (Y) filter region, and the second filter region 12 is, for example, a cyan (C) filter region.

The filter 10 includes two or more color filter regions. The color filter regions each have a non-symmetric shape with respect to the optical center of the image capture device. Part of the wavelength band of a light transmitting a color filter region overlaps with part of the wavelength band of a light transmitting another color filter region, for example. The wavelength band of a light transmitting a color filter region may include, for example, a wavelength band of the light transmitting another color filter region. In the following, the description will be given as an example using the filter 10 of FIG. 2.

The first filter region 11 and the second filter region may be a filter changing a transmittance of an arbitrary wavelength band, a polarization filter passing a polarized light in an arbitrary direction, or a microlens changing a focusing power of an arbitrary wavelength band. For example, the filter changing the transmittance of an arbitrary wavelength band may be a primary color filter (RGB), a complementary color filter (CMY), a color compensating filter (CC-RGB/CMY), an infrared/ultraviolet cutoff filter, an ND filter, or a shielding plate. When the first filter region 11 and the second filter region 12 are microlenses, a distribution of focused light rays is deviated by the lens 20, and thus a blur shape changes.

In the following, a case where the first filter region 11 is a yellow (Y) filter region and the second filter region 12 is a cyan (C) filter region will be exemplified in order to help with understanding.

When the filter 10 is disposed in an aperture of the camera, a structured aperture of which the aperture is divided into two color parts constitutes a color-filtered aperture. The image sensor 30 generates an image based on light rays transmitting the color-filtered aperture. The lens 20 may be disposed between the filter 10 and the image sensor 30 on an optical path through which the light is incident into the image sensor 30. The filter 10 may be disposed between the lens 20 and the image sensor 30 on the optical path through which the light is incident into the image sensor 30. When multiple lenses 20 are provided, the filter 10 may be disposed between two lenses 20.

More specifically, the light of the wavelength band corresponding to a second sensor 32 transmits both the first filter region 11 of yellow and the second filter region 12 of cyan. The light of the wavelength band corresponding to a first sensor 31 transmits the first filter region 11 of yellow but does not transmit the second filter region 12 of cyan. The light of the wavelength band corresponding to a third sensor 33 transmits the second filter region 12 of cyan but does not transmit the first filter region 11 of yellow.

Transmitting a light of a certain wavelength band through a filter or a filter region means transmitting (passing) the light of the wavelength band through the filter or the filter region at a high transmittance. This means that the attenuation of the light (that is, a reduction of the amount of light) of the wavelength band due to the filter or the filter region is extremely small. Not transmitting the light of a certain wavelength band through a filter or a filter region means shielding the light by the filter or the filter region, for example, transmitting the light of the wavelength region through the filter or the filter region at a low transmittance. This means that the attenuation of the light of the wavelength band due to the filter or the filter region is extremely large. The filter or the filter region attenuates the light by, for example, absorbing the light of a certain wavelength band.

FIG. 3 illustrates an example of the transmittance characteristics of the first filter region 11 and the second filter region 12. The transmittance to the light of a wavelength longer than 700 nm in a visible light wavelength band is not illustrated, but the transmittance is near to the case of 700 nm. In the transmittance characteristic 21 of the first filter region 11 of yellow in FIG. 3, the light corresponding to the R image having a wavelength band of about 620 nm to 750 nm and the G image having a wavelength band of about 495 nm to 570 nm is transmitted at a high transmittance, and most of the light corresponding to the B image of a wavelength band of about 450 nm to 495 nm is not transmitted. In addition, in a transmittance characteristic 22 of the second filter region 12 of cyan, the light of the wavelength band corresponding to the B and G images is transmitted at a high transmittance, and most of the light of the wavelength band corresponding to the R image is not transmitted.

Therefore, the light of the wavelength band corresponding to the R image transmits only the first filter region 11 of yellow, and the light of the wavelength band corresponding to the B image transmits only the second filter region 12 of cyan.

The blur shapes on the R and B image change depending on a distance (or a depth) d to the object. In addition, each of the filter regions 11 and 12 has a non-point-symmetric shape with respect to the optical center 13. Therefore, the directions of blur deviation on the R and B images are inverted according to whether the object is on the near side or on the deep side from a focus position when viewed from an image capture point. The focus position is a point away from the image capture point by a focus distance d_{f}, and is a focused position at which the blur does not occur on the image captured by the image capture device 100.

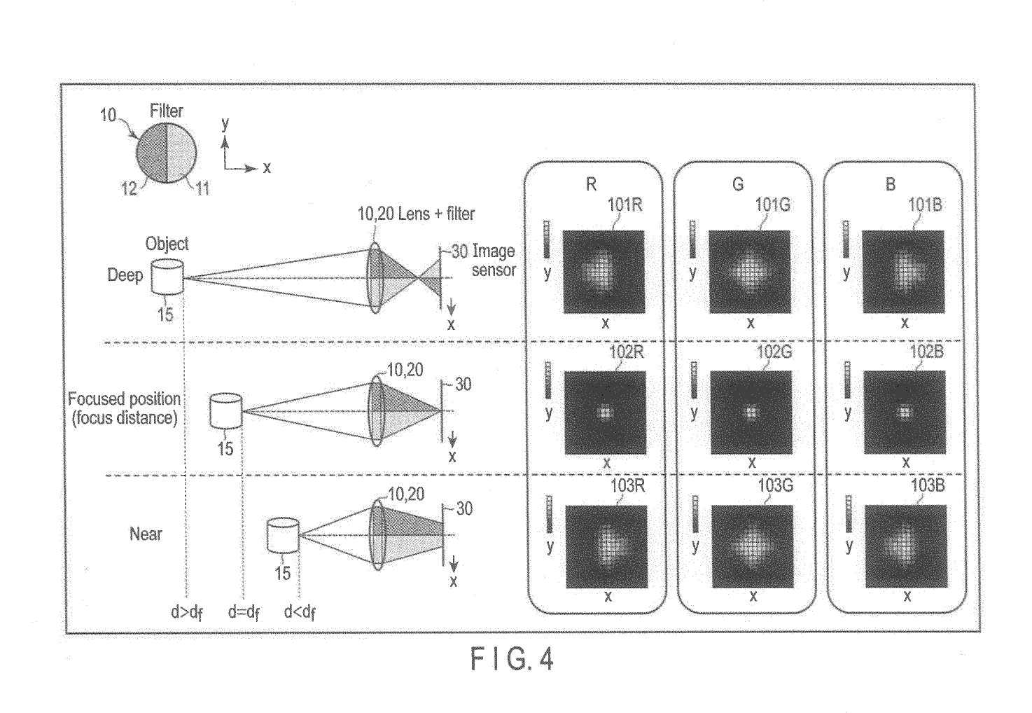

The description will be given about a change of the light rays and the blur shape due to the color-filtered aperture where the filter 10 is disposed, with reference to FIG. 4.

When an object 15 is on the deep side from the focus distance d_{f} (focus position) (d>d_{f}), blur occurs in an image captured by the image sensor 30. A blur function indicating a shape of blur on the image is different among the R image, the G image, and the B image. That is, a blur function 101R of the R image indicates the blur shape deviated to the left side, a blur function 101G of the G image indicates the blur shape without deviation, and a blur function 101B of the B image indicates the blur shape deviated to the right side.

When the object 15 is at the focus distance d_{f} (d=d_{f}), blur almost does not occur in an image captured by the image sensor 30. A blur function indicating a shape of blur on the image is almost the same among the R image, the G image, and the B image. That is, a blur function 102R of the R image, a blur function 102G of the G image, and a blur function 102B of the B image show blur shapes without deviation.

When the object 15 is on the near side from the focus distance d_{f} (d<d_{f}), blur occurs in an image captured by the image sensor 30. A blur function indicating a shape of blur on the image is different among the R image, the G image, and the B image. That is, a blur function 103R of the R image indicates the blur shape deviated to the right side, a blur function 103G of the G image shows the blur shape without deviation, and a blur function 103B of the B image shows the blur shape deviated to the left side.

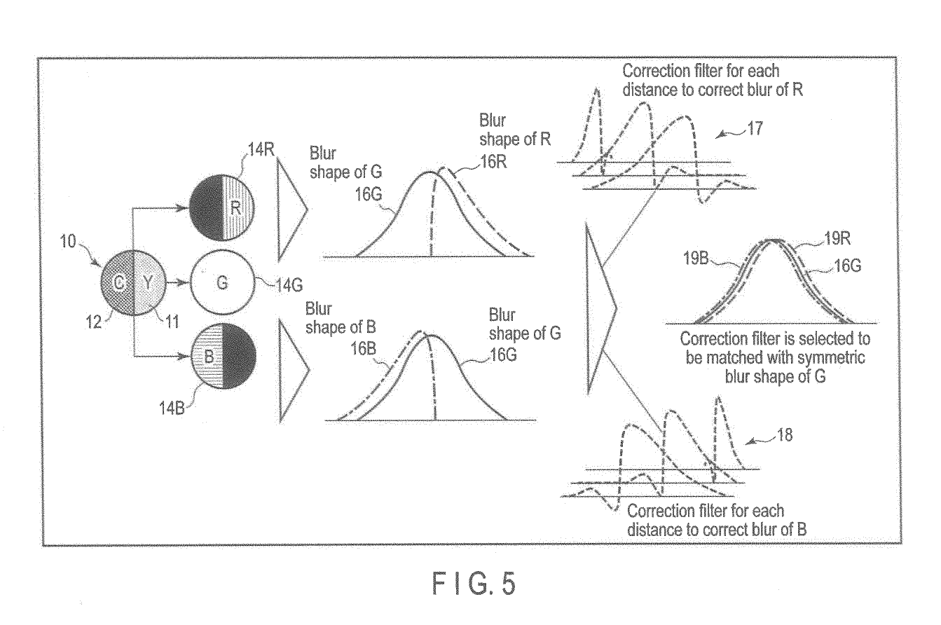

FIG. 5 illustrates a method of calculating a distance to the object 15 using blur on an image. In the example illustrated in FIG. 5, the first filter region 11 of yellow and the second filter region 12 of cyan constitute the filter 10. Therefore, the light of the wavelength band corresponding to the R image passes through a portion 14R corresponding to the first filter region 11, the light of the wavelength band corresponding to the G image passes through a portion 14G corresponding to the first filter region 11 and the second filter region 12, and the light of the wavelength band corresponding to the B image passes through a portion 14B corresponding to the second filter region 12.

When blur occurs on an image captured using the filter 10, a different shape of blur occurs on the R image, the G image, and the B image, respectively. As illustrated in FIG. 5, a blur function 16G of the G image indicates a point-symmetric shape of blur. A blur function 16R of the R image and a blur function 16B of the B image indicate a non-point-symmetric shape of blur, and are different in the deviation of blur.

Blur correction filters 17 and 18 configured to correct the non-point-symmetric blur on the R image and the B image into point-symmetric blur based on blur estimated per distance to an object are applied to the blur function 16R of the R image and the blur function 16B of the B image. Then, a determination is made as to whether the blur functions 16R and 16B match with the blur function 16G of the G image. A plurality of blur correction filters corresponding to a plurality of distances is prepared as the blur correction filters 17 and 18 per distance at a specific interval. When a blur function 19R applied with the blur correction filter 17 or a blur function 19B applied with the blur correction filter 18 matches with the blur function 16G of the G image, the distance corresponding to the blur correction filter 17 or 18 is determined as the distance to the captured object 15.

Determining whether a blur function matches with another blur function can employ a correlation between the R image or B image applied with the blur correction filter and the G image. Therefore, for example, retrieving a blur correction filter, for which a correlation between the R image or B image applied with the blur correction filter and the G image is higher, from among the blur correction filters achieves estimating a distance to the object captured in each pixel on the image. That is, a corrected image obtained by correcting a blur shape of the R or B image is generated using the plurality of blur correction filters created on an assumption that the distance to the object shown in the image is arbitrary, and a distance at which the correlation between the generated corrected image and the G image is higher is found. Therefore, the distance to the object can be calculated.

However, the process of calculating the distance to the object using a number of blur correction filters causes a high calculation cost. Therefore, the distance to the object may be not used as its usage required in real time depending on the number of prepared correction filters. In addition, an exact distance to the object is not necessary depending on the usage. For example, only the determination on whether the object is on the deep side of a reference position or on the near side of the reference position may be sufficient.

Therefore, in this embodiment, by using the image captured using the color-filtered aperture disposed with the filter 10, the distance to the object is not calculated, but it is determined whether the object is on the deep side of the reference position, or on the near side of the reference position. In this embodiment, for example, a blur deviation of a color component that contains a blur having a shape expressed by the non-point-symmetric blur function is determined, so that a relative position of the object with respect to the reference position can be determined at a high speed. A distance (hereinafter, also referred to as a reference distance) from a capture position to the reference position may be the focus distance, or may be an arbitrary distance designated by a user.

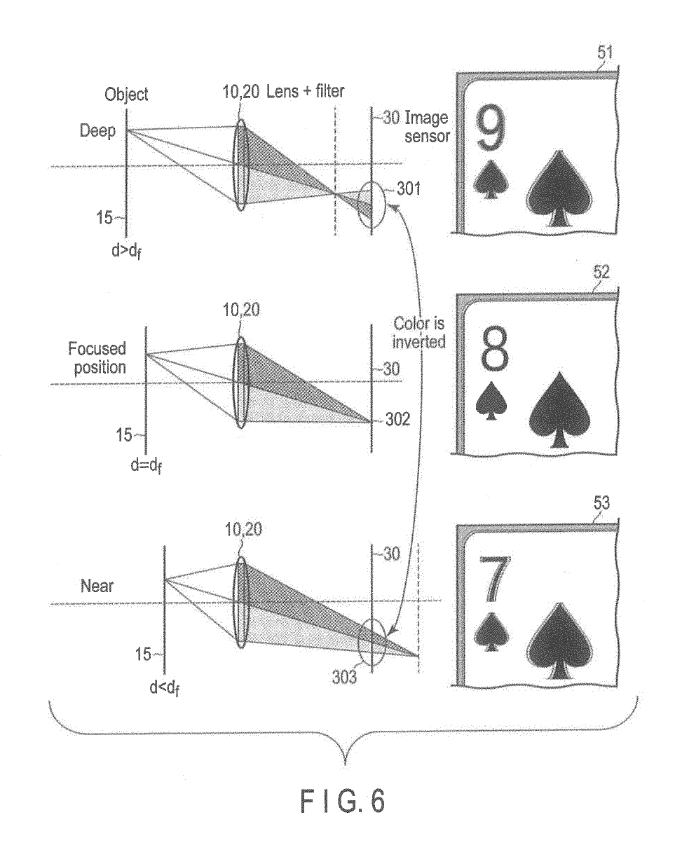

FIG. 6 illustrates an example of an image captured by the image capture device 100. Herein, the description will be exemplified about an example in a case where the reference distance is the focus distance. Further, the object 15 in the case of d>d_{f} is shown as a trump card of Spade 9. The object 15 in the case of d=d_{f} is shown as a trump card of Spade 8. The object 15 in the case of d<d_{f} is shown as a trump card of Spade 7.

When the object 15 is at the focus distance d_{f} (d=d_{f}), the rays (light flux) corresponding to one point on the object 15 are collected in a narrow range (for example, one point) 302 on the image sensor 30. Therefore, an image 52 having no blur is generated. With this regard, when the object 15 is on the deep side from the focus distance d_{f} (d>d_{f}), the rays corresponding to one point on the object 15 are not collected at one point on the image sensor 30 compared to the case where the object 15 is at the focus distance d_{f}, and is spread in a wide range. Therefore, an image 51 containing a blur 301 is generated. In addition, when the object 15 is on the near side from the focus distance d_{f} (d<d_{f}), the rays corresponding to one point on the object 15 are not collected at one point on the image sensor 30 compared to the case where the object 15 is at the focus distance d_{f}, and is spread in a wide range. Therefore, an image 53 containing a blur 303 is generated.

As illustrated in FIG. 6, in the blur 301 on the captured image 51 of the object 15 on the deep side and the blur 303 on the captured image 53 of the object 15 on the near side, the respective portions affected by the two color filter regions 11 and 12 are inverted. In this embodiment, it is possible to determine whether the object 15 is on the deep side of the focus distance d_{f} or on the near side of the focus distance d_{f} by detecting the inversion as a deviation of blur on the R and B images.

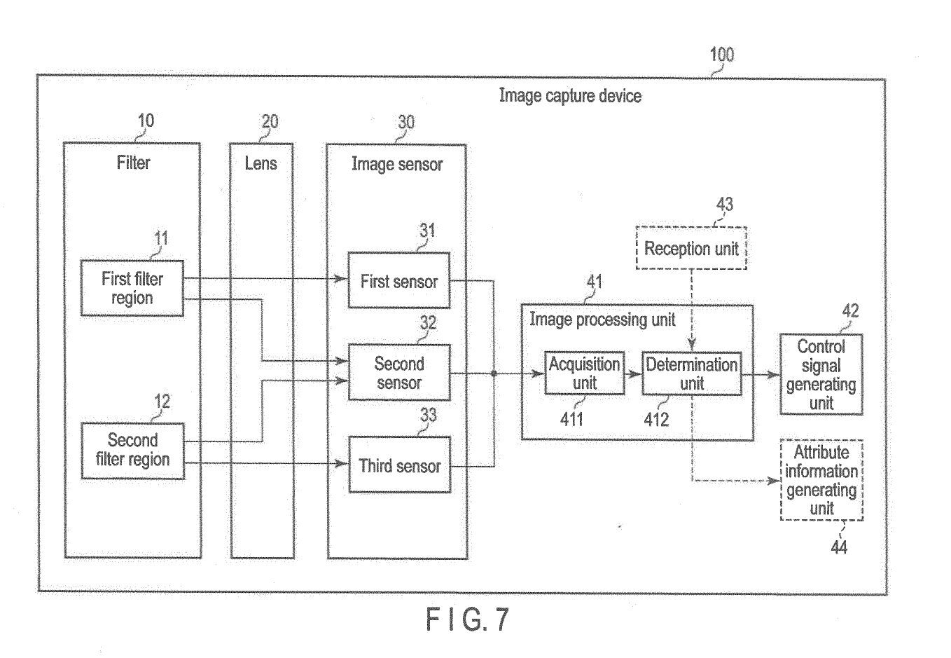

An example of a functional configuration of the image capture device 100 will be described with reference to FIG. 7. As described above, the image capture device 100 includes the filter 10, the lens 20, and the image sensor 30. Each arrow from the filter 10 to the image sensor 30 indicates a path of a light. The filter 10 includes the first filter region 11 and the second filter region 12. The first filter region 11 is, for example, a filter region of yellow. The second filter region 12 is, for example, a filter region of cyan. The image sensor 30 includes the first sensor 31, the second sensor 32, and the third sensor 33. The first sensor 31 includes, for example, imaging elements which receive a red (R) light. The second sensor 32 includes, for example, imaging elements which receive a green (G) light. The third sensor 33 includes, for example, imaging elements which receive a blue (B) light. The image sensor 30 generates an image using the electric signal acquired by photoelectrically converting the received light. The generated image may include an R component, a G component and a B component, or may be three images of an R image, a G image and a B image.

The image capture device 100 further includes an image processing unit 41 and a control signal generating unit 42. Each arrow from the image sensor 30 to the control signal generating unit 42 indicates a path of the electric signal. Hardware (circuit), software (program) executed by the CPU 40, or a combination of software and hardware can realize the respective functional configurations of the image Capture device 100 including the image processing unit 41 and the control signal generating unit 42.

The image processing unit 41 determines whether the object captured in the image is on the near side or on the deep side of the reference position based on the blur on the image generated by the image sensor 30. The image processing unit 41 includes an acquisition unit 411 and a determination unit 412.

The acquisition unit 411 acquires images generated by the image sensor 30. The acquisition unit 411 acquires, for example, an image of a first color component that has a non-point-symmetric blur function and captures a first object, and an image of a second color component that has a point-symmetric blur function and captures the first object. The first color component is, for example, the R component or the B component, and the second color component is, for example, the G component. The acquisition unit 411 may acquire, for example, an image including pixels each having at least one color component. In this image, blur does not occur in a pixel for which the distance to the object is the focus distance, and blur occurs in a pixel for which the distance to the object is not the focus distance. Further, the blur function indicative of blur of the first color component of the pixels is non-point-symmetric.

The determination unit 412 determines whether the first object is on the near side of the reference position (first position) or on the deep side of the reference position when viewed from the capture position based on the image of the first color component and the image of the second color component. The reference position is, for example, a point at which a distance from the capture position is the reference distance. The reference distance may be the focus distance, or may be an arbitrary distance designated by the user. The image capture device 100 may also include a reception unit 43 that receives information input by the user. The reception unit 43 may receive information indicating the reference distance and information designating a processing target pixel on the acquired image. The reference distance may be calculated from a reference surface given by the user. Alternatively, the reception unit 43 may receive information related to a reference plane in place of the reference distance. The reference surface may be a flat surface, a curved surface or a discontinuous surface. For example, the user may input information indicating the reference distance through an input device such as a mouse, a keyboard or a touch screen display, or may designate a region where a processing target pixel on the image is included. When the reception unit 43 receives information designating a processing target pixel on the image, the determination unit 412 may determine whether the first object containing the processing target pixel is on the near side or on the deep side of the reference position when viewed from the capture position.

In addition, the determination unit 412 may determine a deviation of blur of the first color component on the acquired image. The determination unit 412 determines whether the object is on the near side or on the deep side of the reference position based on the deviation of blur of the first color component. When the reception unit 43 receives the information designating the processing target pixel on the image, the determination unit 412 may determine the deviation of blur of the first color component of the processing target pixel.

The control signal generating unit 42 generates various control signals for controlling the image capture device 100 and/or an external device based on a determination result of the determination unit 412 on whether the object is on the near side and on the deep side of the reference position. The control signal generating unit 42 detects, for example, an event that the object comes at the reference position, or an event that the object go away from the reference position based on the determination result, and generates various control signals for controlling the image capture device 100 and/or the external device.

Further, the determination unit 412 also outputs the determination result indicating that the object is on the near side or on the deep side of the reference position, to the external device.

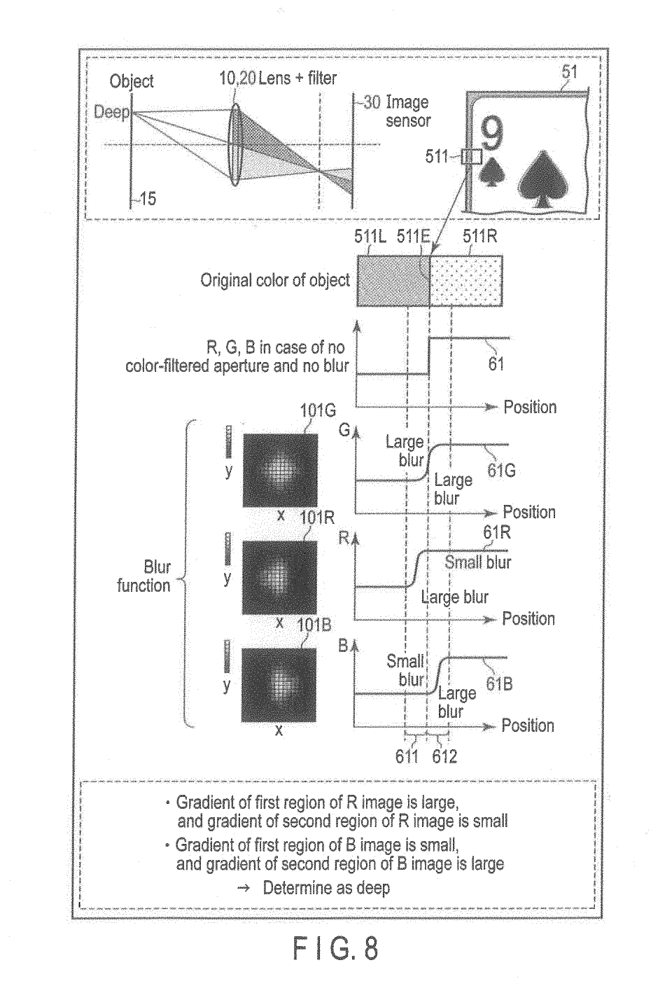

Next, the description will be given with reference to FIGS. 8 to 11 about some examples of determining whether the object is on the near side or on the deep side from the focus distance (focus position) based on the deviation of blur. In the examples illustrated in FIGS. 8 to 11, the determination unit 412 detects an edge from the image of the color component (for example, the G component) in which a point-symmetric blur is contained in the color components in the acquired image. Then, the determination unit 412 determines the deviation of blur using pixels in an edge region corresponding to the edge on the image of the color component (for example, the R or B component) in which a non-point-symmetric blur is contained in the color components in the acquired image. Then, the determination unit 412 determines whether an object having the edge is on the near side or on the deep side of the focus distance based on the deviation of blur.

FIG. 8 illustrates an example of determining that the object 15 is on the deep side from the focus distance using the pixels in an edge region 511 that is a boundary between a dark color (for example, black) and a bright color (for example, white) on the image 51. In the following, the R component, the G component and the B component of the image 51 are also called the R image, the G image and the B image, respectively.

Originally, that is, if there is no color-filtered aperture where the filter 10 is disposed and no blur, the edge region 511 is configured by a dark color region 511L on the left side and a bright color region 511R on the right side. A boundary between these dark and bright color regions 511L and 511R is an edge 511E. Therefore, a relation 61 between the positions of the pixels and the pixel values in these regions 511L and 511R on each of the R image, the G image and the B image shows a sharp edge shape.

In practice, the edge region 511 is affected by the color-filtered aperture, and contains the blur. Therefore, a first region 611 on the left side and a second region 612 on the right side of the edge 511E on the image 51 have a tinge of red.

More specifically, in the edge region 511 on the G image, there occurs a point-symmetric blur that is expressed by the blur function 101G. Therefore, a relation 61G between the positions of the pixels and the pixel values in the edge region 511 on the G image snows that a large blur occurs on both of the first region 611 on the left side of the edge 511E and the second region 612 on the right side of the edge 511E.

In the edge region 511 on the R image, there occurs a non-point-symmetric blur that is deviated to the left side and is expressed by the blur function 101R. Therefore, a relation 61R between the positions of the pixels and the pixel values in the edge region 511 on the R image shows that a large blur occurs in the first region 611 on the left side of the edge 511E and a small blur occurs in the second region 612 on the right side of the edge 511E.

In the edge region 511 on the B image, there occurs the non-point-symmetric blur that is deviated to the right side and is expressed by the blur function 101B. Therefore, a relation 61B between the positions of the pixels and the pixel values in the edge region 511 on the B image shows that a small blur occurs in the first region 611 on the left side of the edge 511E, and a large blur occurs in the second region 612 on the right side of the edge 511E.

In this way, the light of the red wavelength band and the light of the blue wavelength band pass through part of the filter, and thus the non-point-symmetric blur occurs.

Therefore, when the object 15 is on the deep side from the focus distance, the edge region 511 has a characteristic that a gradient of the first region 611 on the R image is large and a gradient of the second region 612 on the R image is small, and a characteristic that the gradient of the first region 611 on the B image is small and the gradient of the second region 612 on the B image is large.

On the basis of these characteristics, the determination unit 412 determines that the object 15 is on the deep side from the focus distance based on, for example, (1) that the gradient of the first region 611 on the R image is equal to or more than a first threshold and the gradient of the second region 612 on the R image is less than a second threshold, and/or (2) that the gradient of the first region 611 on the B image is less than the second threshold and the gradient of the second region 612 on the B image is equal to or more than the first threshold, by using the pixels in the edge region 511.

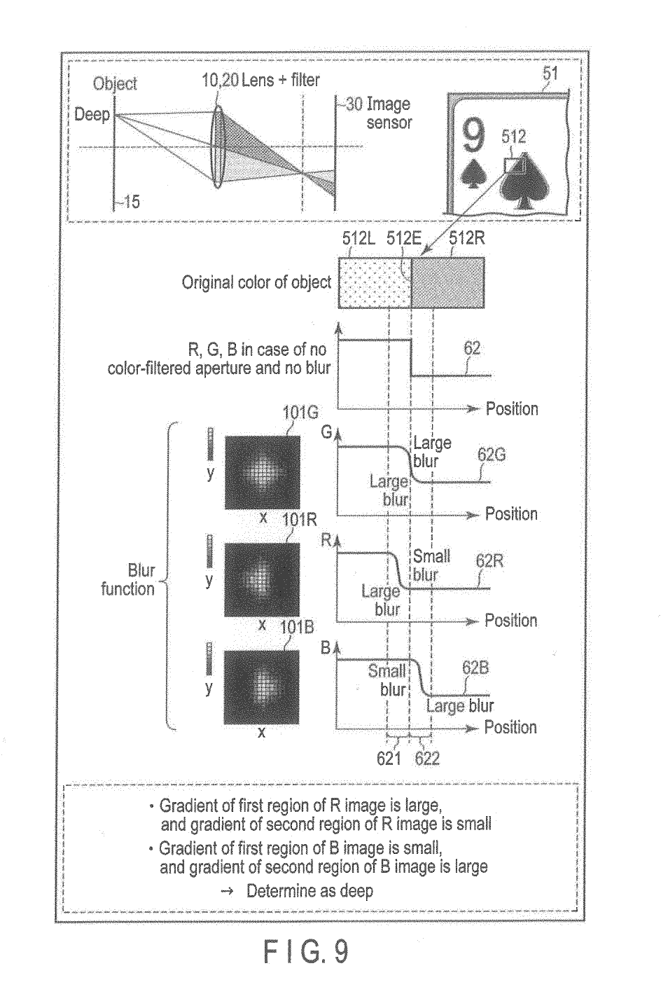

FIG. 9 illustrates an example of determining that the object 15 is on the deep side from the focus distance using the pixels in an edge region 512 which is a boundary between the bright color and the dark color on the image 51.

Originally, that is, if there is no color-filtered aperture where the filter 10 is disposed and no blur, the edge region 512 is configured by a bright color region 512L on the left side and a dark color region 512R on the right side. A boundary between these bright and dark color regions 512L and 512R is an edge 512E. Therefore, a relation 62 between the positions of the pixels and the pixel values in these regions 512L and 512R of the blur on each of the R image, the G image, and the B image shows a sharp edge shape.

In practice, the edge region 512 is affected by the color-filtered aperture, and contains the blur. Therefore, a first region 621 on the left side and a second region 622 on the right side of the edge 512E on the image 51 have a tinge of blue.

More specifically, in the edge region 512 on the G image, there occurs a point-symmetric blur that is expressed by the blur function 101G. Therefore, a relation 62G between the positions of the pixels and the pixel values in the edge region 512 on the G image shows that a large blur occurs on both of the first region 621 on the left side of the edge 512E and the second region 622 on the right side of the edge 512E.

In the edge region 512 on the R image, there occurs a non-point-symmetric blur that is deviated to the left side and is expressed by the blur function 101R. Therefore, a relation 62R between the positions of the pixels and the pixel values in the edge region 512 on the R image shows that a large blur occurs in the first region 621 on the left side of the edge 512E and a small blur occurs in the second region 622 on the right side of the edge 512E.

In the edge region 512 on the B image, there occurs the non-point-symmetric blur which is deviated to the right side and is expressed by the blur function 101B. Therefore, a relation 62B between the positions of the pixels and the pixel values in the edge region 512 on the B image shows that a small blur occurs in the first region 621 on the left side of the edge 512E, and a large blur occurs in the second region 622 on the right side of the edge 512E.

Therefore, when the object 15 is on the deep side from the focus distance, the edge region 512 has a characteristic that a gradient of the first region 621 on the R image is large and a gradient of the second region 622 on the R image is small, and a characteristic that the gradient of the first region 621 on the B image is small and the gradient of the second region 622 on the B image is large.

On the basis of these characteristics, the determination unit 412 determines that the object 15 is on the deep side from the focus distance based on, for example, (1) that the gradient of the first region 621 on the R image is equal to or more than the first threshold and the gradient of the second region 622 on the R image is less than the second threshold, and/or (2) that the gradient of the first region 621 on the B image is less than the second threshold and the gradient of the second region 622 on the B image is equal to or more than the first threshold, by using the pixels in the edge region 512.

In this way, it is possible to determine whether the object is on the near side or on the deep side of the focus distance by using the edge region of the image generated by the light of the wavelength band where the point-symmetric blur occurs and the edge region of the image generated by the light of the wavelength band where the non-point-symmetric blur occurs.

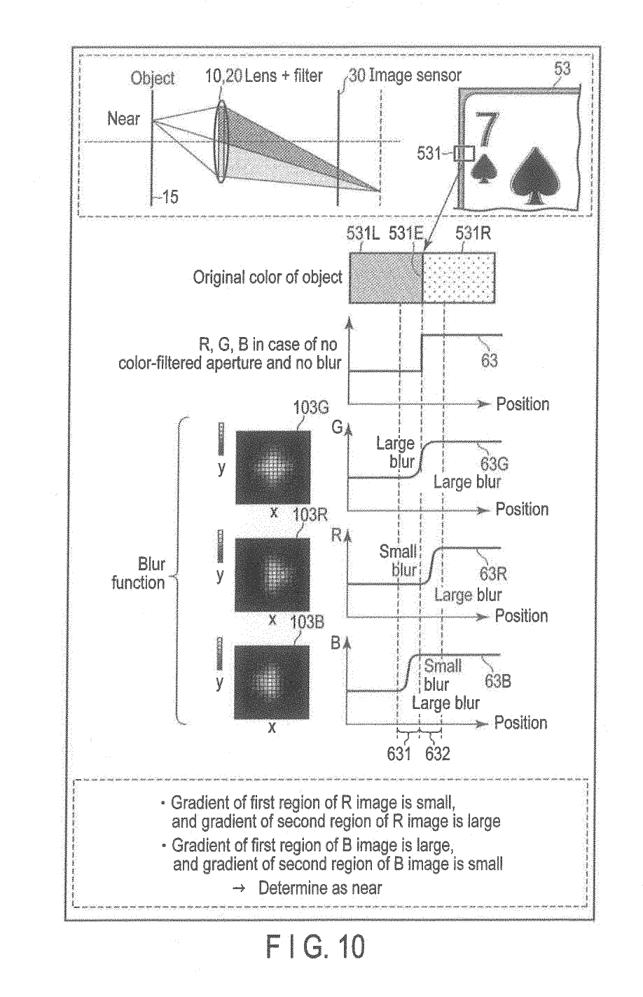

FIG. 10 illustrates an example of determining that the object 15 is on the near side from the focus distance using the pixels in an edge region 531 which is a boundary between the dark color and the bright color on the image 53.

Originally, that is, if there is no color-filtered aperture where the filter 10 is disposed and no blur, the edge region 531 is configured by a dark color region 531L on the left side and a bright color region 531R on the right side. A boundary between these dark and bright color regions 531L and 531R is an edge 531E. Therefore, a relation 63 between the positions of the pixels and the pixel values in these regions 531L and 531R of the blur on each of the R image, the G image and the B image shows a sharp edge shape.

In practice, the edge region 531 is affected by the color-filtered aperture, and contains the blur. Therefore, a first region 631 on the left side and a second region 632 on the right side of the edge 531E on the image 53 have a tinge of bine.

More specifically, in the edge region 531 on the G image, there occurs a point-symmetric blur expressed by the blur function 103G. Therefore, a relation 63G between the positions of the pixels and the pixel values in the edge region 531 on the G image shows that a large blur occurs on both of the first region 631 on the left side of the edge 531E and the second region 632 on the right side of the edge 531E.

In the edge region 531 on the R image, there occurs a non-point-symmetric blur that is deviated to the right side and is expressed by the blur function 103R. Therefore, a relation 63R between the positions of the pixels and the pixel values in the edge region 531 on the R image shows that a small blur occurs in the first region 631 on the left side of the edge 531E and a large blur occurs in the second region 632 on the right side of the edge 531E.

In the edge region 531 on the B image, there occurs the non-point-symmetric blur that is deviated to the left side and is expressed by the blur function 103B. Therefore, a relation 63B between the positions of the pixels and the pixel values in the edge region 531 on the B image shows that a large blur occurs in the first region 631 on the left side of the edge 531E, and a small blur occurs in the second region 632 on the right side of the edge 531E.

Therefore, when the object 15 is on the near side from the focus distance, the edge region 531 has a characteristic that a gradient of the first region 631 on the R image is small and a gradient of the second region 632 on the R image is large, and a characteristic that the gradient of the first region 631 on the B image is large and the gradient of the second region 632 on the B image is small.

On the basis of these characteristics, she determination unit 412 determines that the object 15 is on the near side from the focus distance based on, for example, (1) that the gradient of the first region 631 on the R image is less than the second threshold and the gradient of the second region 632 on the R image is equal to or more than the first threshold, and/or (2) that the gradient of the first region 631 on the B image is equal to or more than the first threshold and the gradient of the second region 632 on the B image is less than the second threshold, by using the pixels in the edge region 531.

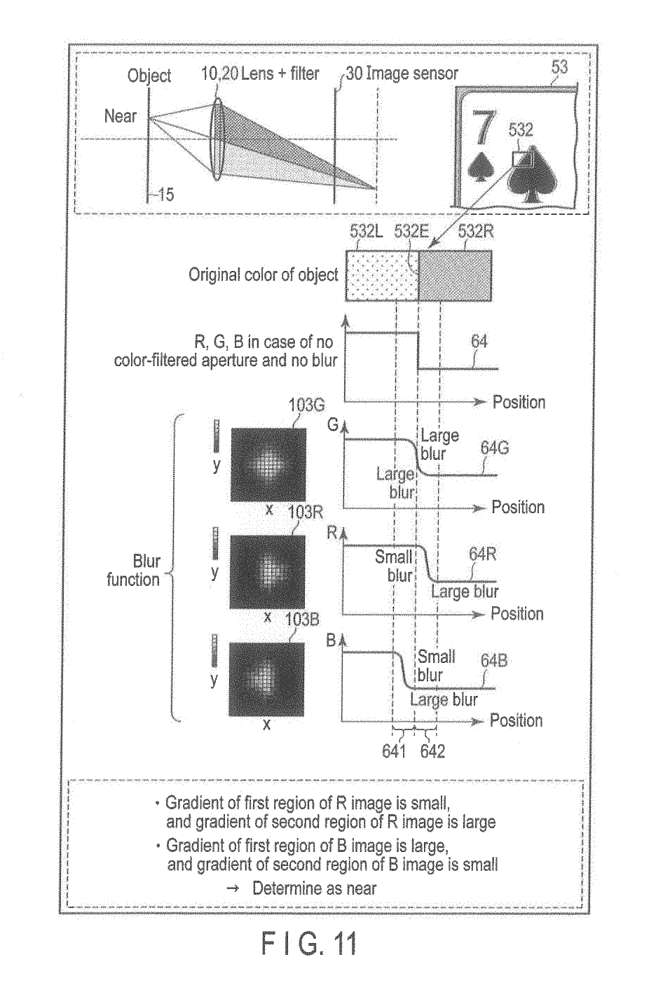

FIG. 11 illustrates an example of determining that the object 15 is on the near side from the focus distance using the pixels in an edge region 532 which is a boundary between the bright color and the dark color on the image 53.

Originally, that is, if there is no color-filtered aperture where the filter 10 is disposed and no blur, the edge region 532 is configured by a bright color region 532L on the left side and a dark color region 532R on the right side. A boundary between these bright and dark color regions 532L and 532R is an edge 532E. Therefore, a relation 64 between the positions of the pixels and the pixel values in these regions 532L and 532R of the blur on each of the R image, the G image and the B image shows a sharp edge shape.

In practice, the edge region 532 is affected by the color-filtered aperture, and contains the blur. Therefore, a first region 641 on the left side and a second region 642 on the right side of the edge 532E on the image 53 have a tinge of red.

More specifically, in the edge region 532 on the G image, there occurs a point-symmetric blur expressed by the blur function 103G. Therefore, a relation 64G between the positions of the pixels and the pixel values in the edge region 532 on the G image shows that a large blur occurs on both of the first region 641 on the left side of the edge 532E and the second region 642 on the right side of the edge 532E.

In the edge region 532 on the R image, there occurs a non-point-symmetric blur which is deviated to the right side and is expressed by the blur function 103R. Therefore, a relation 64R between the positions of the pixels and the pixel values in the edge region 532 on the R image shows that, a small blur occurs in the first region 641 on the left side of the edge 532E and a large blur occurs in the second region 642 on the right side of the edge 532E.

In the edge region 532 on the B image, there occurs the non-point-symmetric blur that is deviated to the left side and is expressed by the blur function 103B. Therefore, a relation 64B between the positions of the pixels and the pixel values in the edge region 532 on the B image shows that a large blur occurs in the first region 641 on the left side of the edge 532E, and a small blur occurs in the second region 642 on the right side of the edge 532E.

Therefore, when the object 15 is on the near side from the focus distance, the edge region 532 has a characteristic that a gradient of the first region 641 on the R image is small and a gradient of the second region 642 is large on the R image, and a characteristic that the gradient of the first region 641 on the B image is large and the gradient of the second region 642 on the B image is small.

On the basis of these characteristics, the determination unit 412 determines that the object 15 is on the near side from the focus distance based on, for example, (1) that the gradient of the first region 641 on the R image is less than the second threshold and the gradient of the second region 642 on the R image is equal to or more than the first threshold, and/or (2) that the gradient of the first region 641 on the B image is equal to or more than the first threshold and the gradient of the second region 642 on the B image is less than the second threshold, by using the pixels in the edge region 532.

In this way, the determination unit 412 determines the deviation of blur shown in the gradient of the region on the left side of the edge and in the gradient of the region on the right side of the edge, so that it is possible to determine whether the object is on the near side or on the deep side from the focus distance.

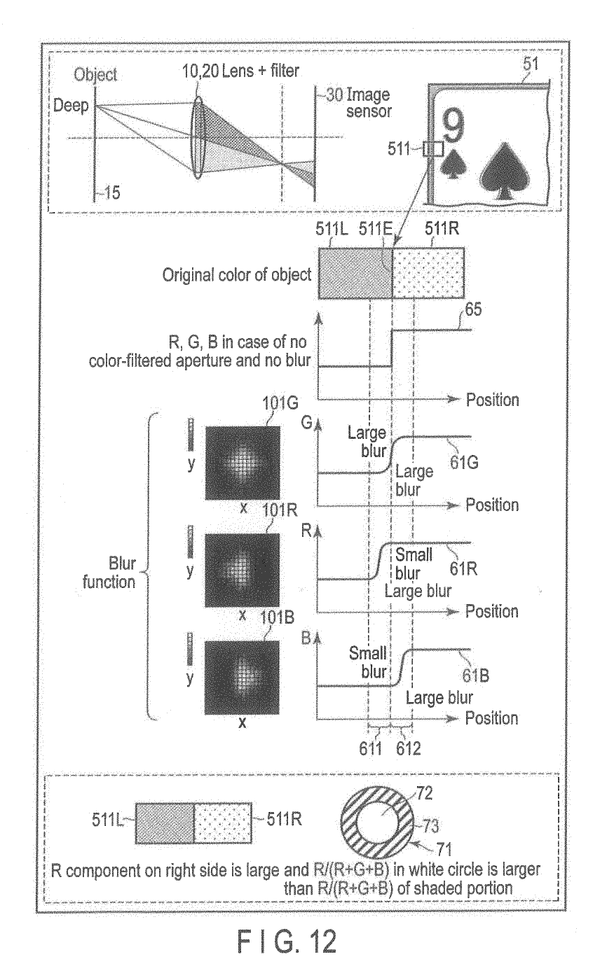

Further, the description will be given with reference to FIGS. 12 to 15 about several examples of the method of determining whether the object is on the near side or on the deep side from the focus distance (focus position) based on the deviation of blur.

FIG. 12 illustrates an example of determining that the object 15 is on the deep side from the focus distance using the pixels in the edge region 511 which is a boundary between the dark color and the bright color on the image 51. The characteristic of the blur occurring in the edge region 511 on the image 51 is as described above with reference to FIG. 8.

The determination unit 412 determines pixels included in an inner circle 72 and pixels included in a shaded portion 73 between the circle 72 and the outer circle when double circle 71 is disposed to be matched in the center in the edge region 511 configured by the dark color region 511L and the bright color region 511R of the R image. The sizes of the circle 72 and the shaded portion 73 forming the double circle 71 can be determined, for example, based on the characteristic of the lens 20 and the size of the edge region 511. For example, the radius of the inner circle 72 can be set to a length from a boundary between the dark color region 51L and the bright color region 511R to a pixel farthest away from the boundary contained in a region where the blur is distributed on the R image. The region where the blur is distributed is changed according to the distance to the object, and is not known in advance. Therefore, the region may be estimated from a profile of the pixel values, or may be set to a value that is not too large.

Even in the G and B images, the double circle 71 is set to be matched with the position of the double circle 71 of the R image. The center of the circle is, for example, set on the boundary between the dark color region 511L and the bright color region 511R.

The determination unit 412 calculates a value of R/(R+G+B) using the pixel values of the R component, the G component and the B component of the pixels contained in each circle 72. In addition, the determination unit 412 calculates a value of R/(R+G+B) using the pixel values of the R component, the G component and the B component of the pixels contained in the shaded portion 73. Then, as illustrated in FIG. 12, the determination unit 412 determines than the object 15 is on the deep side from the focus distance when the R component is large on the right side and the value of R/(R+G+B) in the circle 72 is larger than the value of R/(R+G+B) in the shaded portion 73, in the edge region 511 configured by the dark color region 511L and the bright color region 511R. Further, the shapes of the circles 71 and 72 may be changed to a rectangular shape or a segment. In this case, the shape of the shaded portion 73 is changed with that.

The values of R/(R+G+B) in two regions may be calculated using the color image obtained by combining the R image, the G image and the B image. In addition, the values of R/(R+G) or the values of R/(G+B) in two regions may be calculated in place of R/(R+G′B). The value of R/(R+G+B) of the shaded portion 73 and the circle 72 may be used in place of calculating the value of R/(R+G+) or the shaded portion 73. In place of the double circle 71, a polygonal shape such as a rectangular shape or other shapes overlapping at least in a part or other shapes may be used.

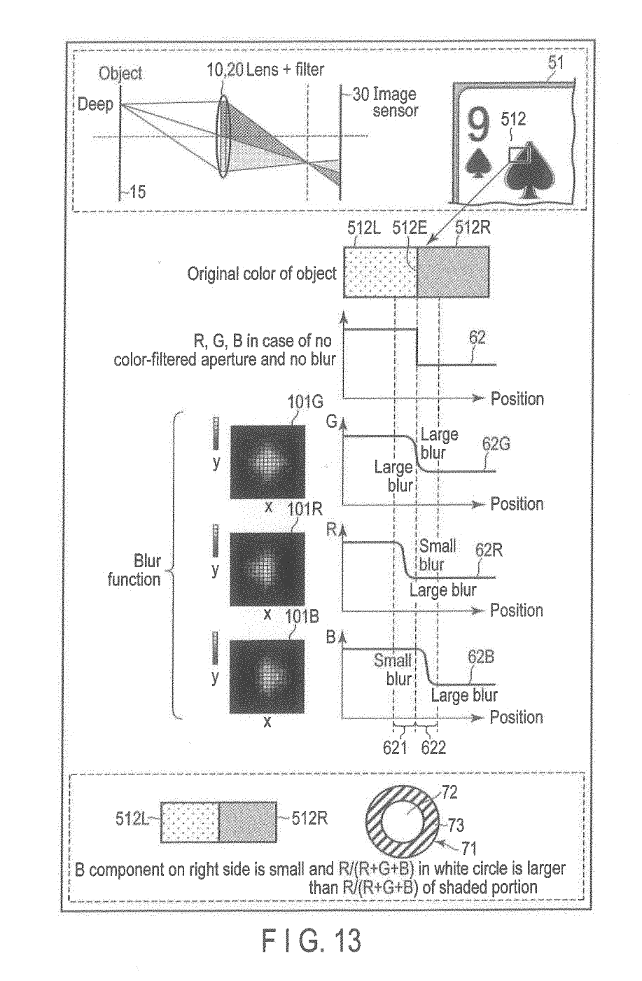

FIG. 13 illustrates an example of determining that the object 15 is on the deep side from the focus distance using the pixels in the edge region 512 that is the boundary between the bright color and the dark color on the image 51. The characteristic of the blur occurring in the edge region 511 on the image 51 is the same as described above with reference to FIG. 9.

The determination unit 412 determines pixels included in an inner circle 72 and pixels included in a shaded portion 73 between the circle 72 and the outer circle when double circle 71 is disposed to be matched in the center in the edge region 512 configured by the bright color region 512L and the dark color region 512R of the B image. The sizes of the circle 72 and the shaded portion 73 forming the double circle 71 can be determined, for example, based on the characteristic of the lens 20 and the size of the edge region 512. For example, the radius of the inner circle 72 can be set to a length from a boundary between the bright color region 512L and the dark color region 512R to a pixel farthest away from the boundary contained in a region where the blur is distributed on the B image. The region where the blur is distributed is changed according to the distance to the object, and is not known in advance. Therefore, the region may be estimated from a profile of the pixel values, or may be set to a value that is not too large.

Even in the G and R images, the double circle 71 is set to be matched with the position of the double circle 71 of the B image. The center of the circle is, for example, set on the boundary between the bright color region 512L and the dark color region 512R.

The determination unit 412 calculates a value of B/(R+G+B) using the pixel values of the R component, the G component and the B component of the pixels contained in each circle 72. In addition, the determination unit 412 calculates a value of B/(R+G+B) using the pixel value of the R component, the G component and the B component of the pixels contained in the shaded portion 73. Then, as illustrated in FIG. 13, the determination unit 412 determines that the object 15 is on the deep side from the focus distance when the B component is small on the right side, and the value of B/(R+G+B) in the circle 72 is larger than the value of B/(R+G+B) in the shaded portion 73, in the edge region 512 configured by the bright color region 512L and the dark color region 512R. Further, the shapes of the circles 71 and 72 may be changed to a rectangular shape or a segment. In this case, the shape of the shaded portion 73 is changed with that.

The values of B/(R+G+B) in two regions may be calculated using the color image obtained by combining the R image, the G image and the B image. In addition, the values of B/(R+G) or the values of B/(G+B) in two regions may be calculated in place of B/(R+G+B). The value of B/(R+G+B) of the shaded portion 73 and the circle 72 may be used in place of calculating the value of B/(R+G+B) of the shaded portion 73. In place of the double circle 71, a polygonal shape such as a rectangular shape overlapping at least in a part or other shapes may be used.

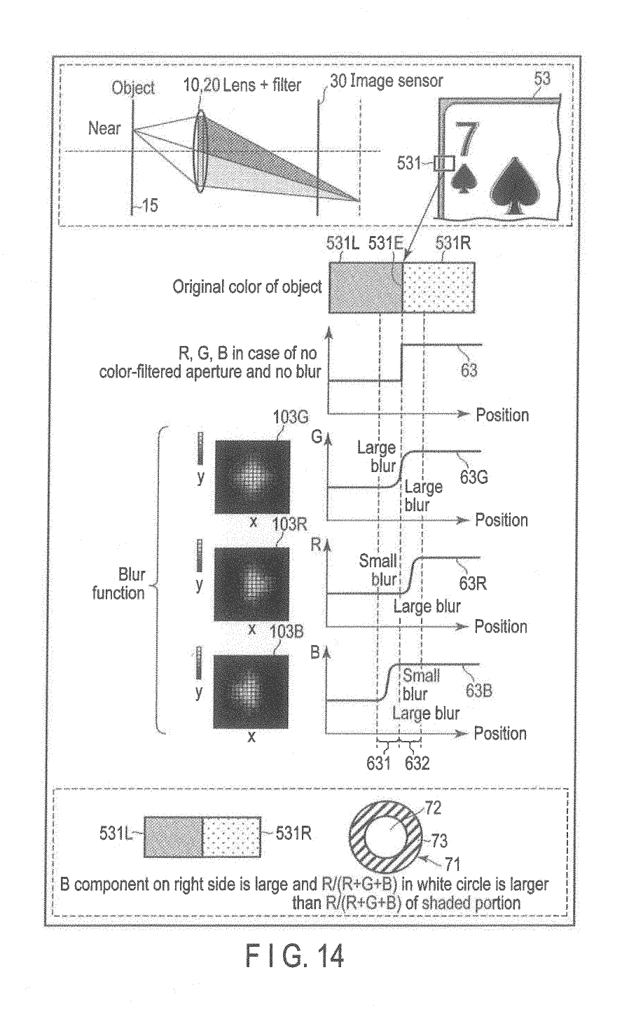

FIG. 14 illustrates an example of determining that the object 15 is on the near side from the focus distance using the pixels in the edge region 531 that is the boundary between the dark color and the bright color on the image 53. The characteristic of the blur occurring In the edge region 531 on the image 53 is the same as described above with reference to FIG. 10.

The determination unit 412 determines pixels included in an inner circle 72 and pixels included in a shaded portion 73 between the circle 72 and the outer circle when double circle 71 is disposed to be matched in the center in the edge region 531 configured by the dark color region 531L and the bright color region 531R of the B image. The sizes of the circle 72 and the shaded portion 73 forming the double circle 71 can be determined, for example, based on the characteristic of the lens 20 and the size of the edge region 531. For example, the radius of the inner circle 72 can be set to a length from a boundary between the dark color region 531L and the bright color region 531R to a pixel farthest away from the boundary contained in a region where the blur is distributed on the B image. The region where the blur is distributed is changed according to the distance to the object, and is not known in advance. Therefore, the region may be estimated from a profile of the pixel values, or may be set to a value that is not too large.

Even in the G and R images, the double circle 71 is set to be matched with the position of the double circle 71 of the B image. The center of the circle is, for example, set on the boundary between the dark color region 531L and the bright color region 531R.

The determination unit 412 calculates a value of B/(R+G+B) using the pixel values of the R component, the G component, and the B component of the pixel contained in each circle 72. In addition, the determination unit 412 calculates a value of B/(R+G+B) using the pixel values of the R component, the G component and the B component of the pixels contained in the shaded portion 73. Then, as illustrated in FIG. 14, the determination unit 412 determines chat the object 15 is on the near side from the focus distance when the B component is large on the right side, and the value of B/(R+G+B) in the circle 72 is larger than the value of B/(R+G+B) in the shaded portion 73, in the edge region 531 configured by the dark color region 531L and the bright color region 531R. Further, the shapes of the circles 71 and 72 may be changed to a rectangular shape or a segment. In this case, the shape of the shaded portion 73 is changed with that.

The values of B/(R+G+B) in two regions may be calculated using the color image obtained by combining the R image, the G image and the B image. In addition, the values of B/(R+G) or the values of B/(G+B) in two regions may be calculated in place of B/(R+G+B). The value of B/(R+G+B) of the shaded portion 73 and the circle 72 may be used in place of calculating the value of B/(R+G+B) of the shaded portion 73. In place of the double circle 71, a polygonal shape such as a rectangular shape overlapping at least in a part or other shapes may be used.

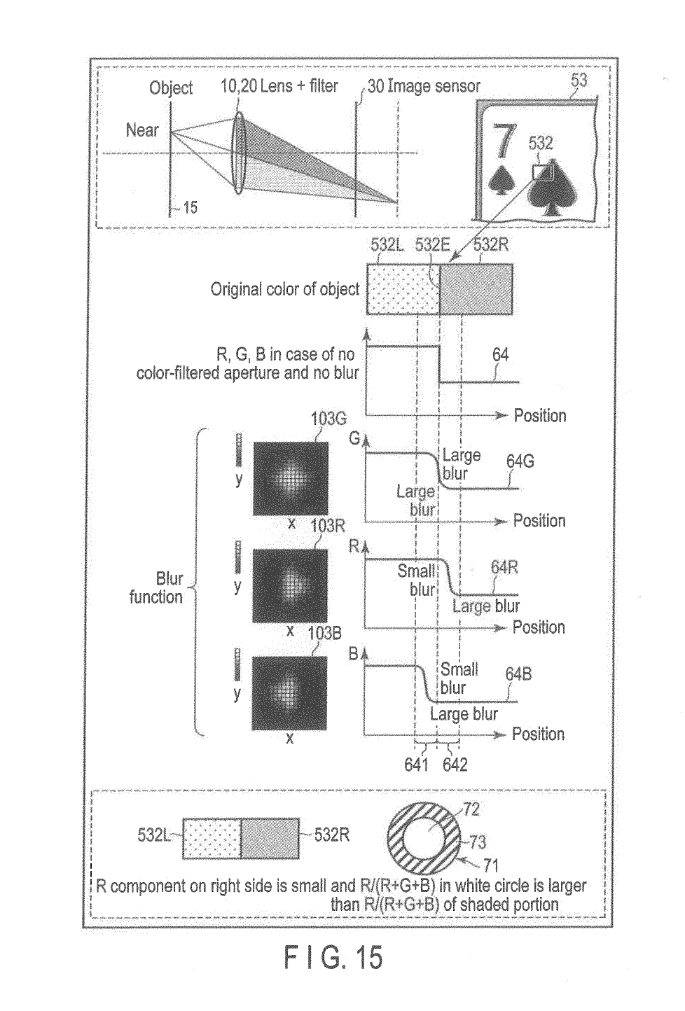

FIG. 15 illustrates an example of determining that the object 15 is on the near side from the focus distance using the pixels in the edge region 532 that is the boundary between the bright color and the dark color on the image 53. The characteristic of the blur occurring in the edge region 532 on the image 53 is as described above with reference to FIG. 11.

The determination unit 412 determines pixels included in an inner circle 72 and pixels included in a shaded portion 73 between the circle 72 and the outer circle when double circle 71 is disposed to be matched in the center in the edge region 532 configured by the bright color region 532L and the dark color region 532R of the R image. The sizes of the circle 72 and the shaded portion 73 forming the double circle 71 can be determined, for example, based on the characteristic of the lens 20 and the size of the edge region 532. For example, the radius of the inner circle 72 can be set to a length from a boundary between the bright color region 532L and the dark color region 532R to a pixel farthest away from the boundary contained in a region where the blur is distributed on the R image. The region where the blur is distributed is changed according to the distance to the object, and is not known in advance. Therefore, the region may be estimated from a profile of the pixel values, or may be set to a value that is not too large.

Even in the G and B images, the double circle 71 is set to be matched with the position of the double circle 71 of the R image. The center of the circle is, for example, set on the boundary between the bright color region 532L and the dark color region 532R.

The determination unit 412 calculates a value of R/(R+G+B) using the pixel values of the R component, the G component and the B component of the pixels contained in each circle 72. In addition, the determination unit 412 calculates a value of R/(R+G+B) using the pixel values of the R component, the G component and the B component of the pixels contained in the shaded portion 73. Then, as illustrated in FIG. 15, the determination unit 412 determines that the object 15 is on the near side from the focus distance when the R component is small on the right side, and the value of R/(R+G+B) in the circle 72 is larger than the value of R/(R+G+B) in the shaded portion 73, in the edge region 532 configured by the bright color region 532L and the dark color region 532R. Further, the shapes of the circles 71 and 72 may be changed to a rectangular shape or a segment. In this case, the shape of the shaded portion 73 is changed with that.

The values of R/(R+G+B) in two regions may be calculated using the color image obtained by combining the R image, the G image and the B image. In addition, the values of R/(R+G) or the values of R/(G+B) in two regions may be calculated in place of R/(R+G+B). The value of R/(R+G+B) of the shaded portion 73 and the circle 72 may be used in place of calculating the value of R/(R+G+B) of the shaded portion 73. In place of the double circle 71, a polygonal shape such as a rectangular shape overlapping at least in a part or other shapes may be used.

In this way, the determination unit 412 can determine whether the object is on the near side or on the deep side from the focus distance by determining a deviation of blur that indicates a ratio of the color component in the edge region.

With the above configuration, it is possible to determine whether the object is on the near side or on the deep side from the focus distance (focus position). Since there is no need to calculate the distance from the image capture device to the object, the determination of this embodiment can be performed by a simple process at a high speed.

The reference distance may be the focus distance described above, or other distances may be used. The reference distance may be an arbitrary distance designated by the user. In the following, the description will be given with reference to FIG. 2 about that the object 15 captured in an image is on the near side or on the deep side of the reference distance (reference position) when the image is captured using the color-filtered aperture where the filter 10 is disposed. As described above, when the object 15 at a position not in the focus distance is captured, the blur having the non-point-symmetric shape occurs in the R component (R image) and the B component (B image) of the captured image, and the blur having the point-symmetric shape occurs in the G component (G image). In the following, the R and B images may be called a target image, and the G image may be called a reference image. For example, the target image and the reference image are images captured by one image capture device 100 at the same time.

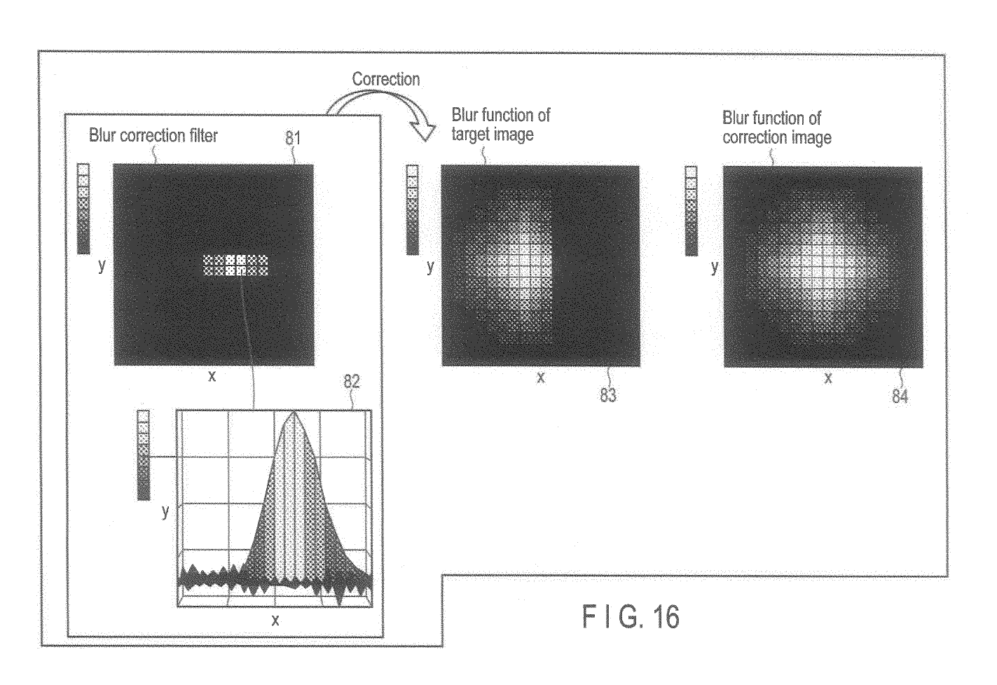

As illustrated in FIG. 16, when a blur correction filter 81 for correcting the blur depending on the distance to the object 15 is applied to the target image having the non-point-symmetric blur expressed by a blur function 83, the blur contained in the corrected image is corrected to be the blur having the point-symmetric shape as illustrated in a blur function 84. The blur correction filter 81 is one-dimensional kernel that subjects a convolution in a horizontal direction to the image. The corrected blur is increased in correlation with the blur of the reference image as a distance assumed to create the blur correction filter 81 approaches an actual distance to the object 15.

Using the characteristic, the determination unit 412 determines whether the object 15 is on the near side or on the deep side from the reference distance by determining a correction image having a high correlation with the reference image having the point-symmetric blur from two correction images that are obtained by applying a first blur correction filter for correcting the blur when the object 15 is on the near side from the reference distance and a second blur correction filter for correcting the blur when the object 15 is on the deep side from the reference distance to the target image having the non-point-symmetric blur. That is, when a correction image having a high correlation with the reference image is an image to which the first blur correction filter is applied, the determination unit 412 determines that the object 15 is on the near side from the reference distance. In addition, when the correction image having a high correlation with the reference image is an image to which the second blur correction filter is applied, the determination unit 412 determines that the object 15 is on the deep side from the reference distance. In other words, it can be said that the determination unit 412 determines whether an actual distance to the object 15 approaches the distance that is assumed by the first blur correction filter and is on the near side from the reference distance or the distance that is assumed by the second blur correction filter and is on the deep side from the reference distance.

More specifically, the determination unit 412 applies the first blur correction filter to the target image having the non-point-symmetric blur to correct the blur when the object 15 is on the near side from the reference distance, and thus calculates a first correction image. The first blur correction filter is, for example, a filter to correct the blur when the object 15 is on the near side by a predetermined distance from the reference distance. In addition, the determination unit 412 applies the second blur correction filter to the target image to correct the blur when the object 15 is on the deep side from the reference distance, and thus calculates a second correction image. The second blur correction filter is, for example, a filter to correct the blur when the object 15 is on the deep side by the predetermined distance from the reference distance.

Next, the determination unit 412 calculates a first correlation value between the first correction image and the reference image. The determination unit 412 also calculates a second correlation value between the second correction image and the reference image. The first correlation value and the second correlation value may be obtained using, for example, a normalized cross-correlation (NCC), a zero-mean normalized cross-correlation (JSNCC), and a color alignment measure.

The determination unit 412 compares the first correlation value with the second correlation value. If the first correlation value is larger than the second correlation value, the determination unit 412 determines chat the object 15 is on the near side from the reference distance. On the other hand, if the second correlation value is larger than the first correlation value, the determination unit 412 determines that the object 15 is on the deep side from the reference distance.

Further, the determination unit 412 may calculate a first difference degree between the first correction image and the reference image, and may calculate a second difference degree between the second correction image and the reference image. If the first difference degree is larger than the second difference degree, the determination unit 412 determines that the object 15 is on the deep side from the reference distance. On the other hand, when the second difference degree is larger than the first difference degree, the determination unit 412 determines that the object 15 is on the near side from the reference distance. The first difference degree and the second difference degree are obtained using, for example, a sum of squared difference (SSD) and a sum of absolute difference (SAD).

With the above configuration, it is possible to determine whether the object is on the deep side or on the near side from the reference distance (reference position) by a simple process at a high speed. The determination unit 412 applies two blur correction filters to the target image. Therefore, it can be said that the calculation cost is less than that in the case of the process of obtaining the distance to the object by applying a number of blur correction filters to the target image as described with reference to FIG. 5.

As described above, the control signal generating unit 42 generates various control signals for controlling the image capture device 100 and the external devices based on the determination result of the determination unit 412 on whether the object is on the near side or on the deep side of the reference distance. The determination unit 412 may transmit a signal containing the determination result to the control signal generating unit 42, and the control signal generating unit 42 may generate the control signal for controlling the focus distance and zooming in or out of the image capture device 100 based on the determination result of the determination unit 412.

Further, the signal generated by the determination unit 412 includes, for example, data on a captured image and data on the determination result on the pixel in the captured image. The data on the captured image is, for example, data on a color space expressed, by RGB or YUV of the pixels. The determination unit 412 can generate (output), for example, a list of sets of three pixel values of RGB or YUV of a pixel and the determination result on the pixel. The sets are arranged in an order of pixels included in the captured image. The order is, for example, an order of raster scanning from the pixel at the left upper end to the pixel at the right lower end of the captured image. In addition, the determination unit 412 may generate data of a list of only determination results arranged in the order, or may generate a list of sets between coordinates of the pixel on the captured image and the determination result on the pixel. As described above, the determination unit 412 can determine whether the object is on the near side or on the deep side of the reference distance with respect to a pixel of a processing target designated in the captured image. Therefore, the list may not include the determination results on all the pixels in the image, but may contain the determination results on some pixels in the image. In addition, an image and a numerical value based on the generated list may be displayed on the display 70. For example, a pop-up screen may be displayed on the captured image displayed on the display 70 to show whether the object is on the near side or on the deep side of the reference distance. In addition, there may be displayed an image by which a user can identify whether the object is on the near side or on the deep side of the reference distance, on the display 70. The displayed image is, for example, an image in which the pixels on the near side of the reference distance and the pixels on the deep side of the reference distance are separated by color.

In addition, for example, when the object to be focused is at a position different from the focus distance, the control signal generating unit 42 generates a control signal for changing the focus distance to the position of the object. The image capture device 100 controls the lens 20 according to the generated control signal to change the focus distance to the near side or to the deep side. Therefore, an automatic focus and a tracking focus can be realized with respect to the object. The position to be focused may be input from the reception unit 43.

In addition, for example, if the object is on the deep side from the reference distance, the control signal generating unit 42 generates a control signal for zooming in. If the object is on the near side from the reference distance, the control signal generating unit 42 generates a control signal for zooming out. The image capture device 100 performs a zoom-in operation or a zoom-out operation by controlling the lens 20 that is a zoom lens according to the generated control signal. Therefore, the object on the image can be kept constant in size. Further, the reference distance may be kept constant even after the zoom-in or zoom-out operation.

Furthermore, when the image capture device 100 is a video recording device that records an image, the control signal generating unit 42 may generate a control signal based on the determination result on whether the object is on the near side or on the deep side from the reference distance. The control signal relates to a recording start of the image, a recording stop of the image, a resolution switching, and/or a compression ratio switching. The video recording device includes a device having a function of recording continuously captured images such as a monitor camera, a drive recorder, and a camera equipped in a drone. The image capture device 100 that is the video recording device performs the recording start of the image, the recording stop of the image, the resolution switching, or the compression rate switching according to the generated control signal. Therefore, when the object is on the near side from the reference distance, the image capture device 100 may start the recording of the image, increase the resolution, or lower the compression ratio. For example, the recording of the image may start, the resolution may be increased, or the compression ratio may be lowered since a time point when a person approaches a region within the reference distance from the monitor camera provided in a house, or a time point immediately before an accident that an object approaches a region within the reference distance from the camera of the drive recorder. In addition, when the object goes away toward the deep side, the image capture device 100 may stop the recording of the image, lower the resolution, or increase the compression ratio. Further, for example, when a distant image containing the object on the deep side of the reference distance is recorded when the image capture device 100 captures the ground from the sky, the resolution may be increased or the compression ratio may be lowered in order to observe a detailed portion of the object in a distance.

In addition, when the image capture device 100 is a video recording device that records an image, the image capture device 100 may include an attribute information generating unit 44 to generate attribute information corresponding to the recorded image. The attribute information generating unit 44 generates the attribute information for at least one image based on the determination result on whether the object is on the near side or on the deep side of the reference distance. For example, the attribute information generating unit 44 generates the attribute information (that is, index) for at least one image corresponding to a scene that the object approaches on the near side. The attribute information generating unit 44 can record the image and the attribute information in association with each other. Therefore, the user can play only the scene of which the attribute information is generated, and can skip other scenes when the user watches a recorded video containing images or recorded images, so that it is possible for the user to efficiently watch only the scene in which an event occurs. On the contrary, the user can efficiently watch only the scene in which an event does not occur by playing the scene in which the attribute information is not generated.

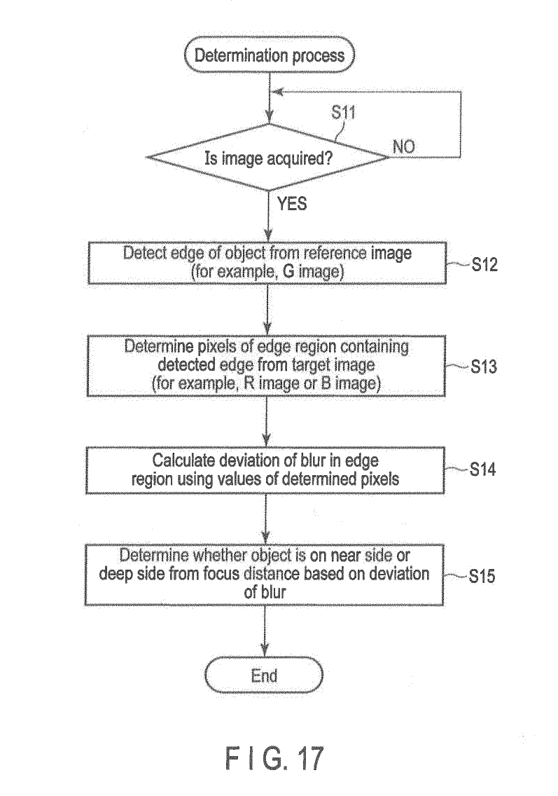

Next, the description will be given with reference to a flowchart of FIG. 17 about an example of the procedure of a determination process executed by the image capture device 100. In the determination process, it is determined whether the object 15 is on the near side or on the deep side from the focus distance (focus position).

First, the CPU 40 of the image capture device 100 determines whether an image is acquired (step S11). When an image is not acquired (No in step S11), it is determined again whether an image is acquired by returning to step S11.

When an image is acquired (Yes in step S11), the CPU 40 sets an image (for example, the G image) of a color component containing a point-symmetric blur of color components in the acquired image as the reference image, and detects an edge of an object from the reference image (step S12). For example, when a difference between the pixel values of an interested pixel on the reference image and an adjacent pixel is equal to or more than a threshold, the CPU 40 detects the interested pixel as the edge.

Next, the CPU 40 sets an image (for example, the R image or the B image) of a color component containing the non-point-symmetric blur of the color components in the acquired image as the target image, and determines pixels corresponding to the edge region containing the edge detected in step S12 from the target image (step S13). The edge region contains, for example, pixels detected as the edge and pixels on either side of them. The CPU 40 calculates a deviation of blur in the edge region using the pixel values of the determined pixels (step S15). The deviation of blur is expressed by, for example, the gradient of the first region and the gradient of the second region in the edge region. For example, the first region contains pixels positioned on the left side of the edge, and the second region contains pixels positioned on the right side of the edge. In this case, the deviation of blur is expressed by a gradient calculated based on the pixel values of the pixels positioned on the left side of the edge and the gradient calculated based on the pixel values of the pixels positioned on the right side of the edge.

Then, the CPU 40 determines whether the object is on the near side or on the deep side from the focus distance based on the calculated deviation of blur (step S15). For example, the CPU 40 determines whether the object is on the near side or on the deep side from the focus distance based on a magnitude relation between the gradient of the first region and the gradient of the second region.

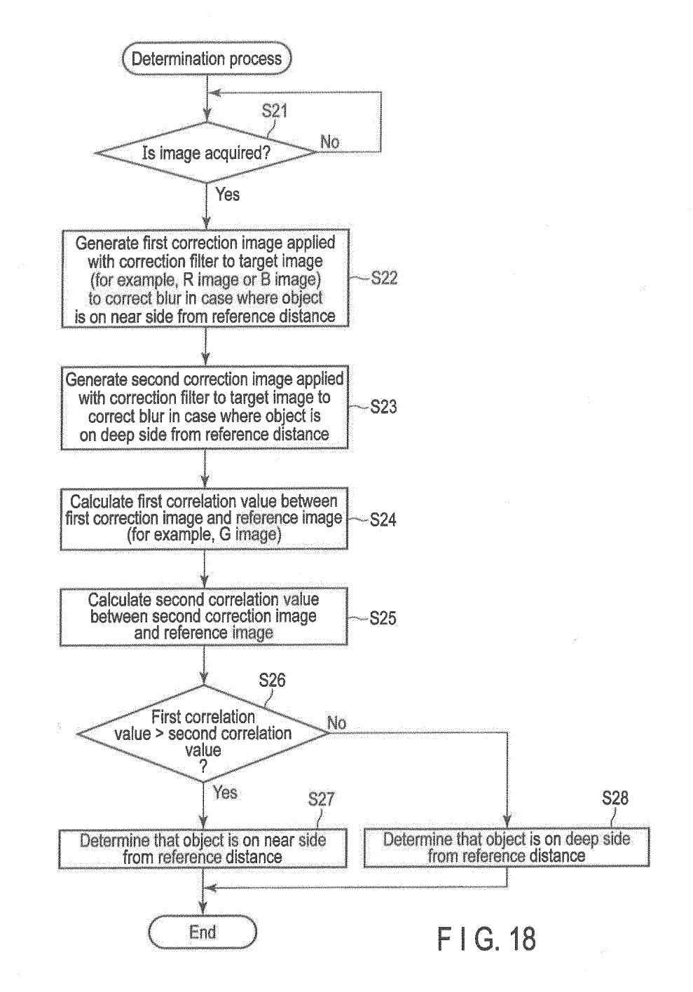

In addition, a flowchart of FIG. 18 illustrates another example of the procedure of the determination process executed by the image capture device 100. In the determination process, it is determined that whether the object 15 is on the near side or on the deep side from the reference distance (reference position).

First, the CPU 40 of the linage capture device 100 determines whether an image is acquired (step S21). When an image is not acquired (No in step S21), it is determined again whether an image is acquired by returning to step S21.

When an image is acquired (Yes in step S21), the CPU 40 sets an image (for example, the G image) of the color component containing the point-symmetric blur of the color components in the acquired image as the reference image, sets an image (for example, the R and B images) of the color component containing the non-point-symmetric blur of the color components as the target image, and applies to the target image a correction filter for correcting the blur when the object is on the near side from the reference distance, so that the first correction image is generated (step S22). In addition, the CPU 40 applies to the target image a correction filter for correcting the blur when the object is on the deep side from the reference distance, so that the second correction image is generated (step S23).

Then, the CPU 40 calculates the first correlation value between the first correction image and the reference image (step S24). In addition, the CPU 40 calculates the second correlation value between the second correction image and the reference image (step S25).

Next, the CPU 40 determines whether the calculated first correlation value is larger than the second correlation value (step S26). If the first correlation value is larger than the second correlation value (Yes in step S26), the CPU 40 determines that the object is on the near side from the reference distance (step S27). On the other hand, if the first correlation value is equal to or less than the second correlation value (No in step S26), the CPU 40 determines that the object is on the deep side from the reference distance (step S28).

Further, the procedures illustrated in FIGS. 17 and 18 may be executed by an image processing device in place of the image capture device 100. The image processing device is realized by a server computer for example, and has a function of exchanging data and signals with the image capture device 100. For example, the image processing device receives an image generated by the image capture device 100 and can determine whether the object is on the near side or on the deep side from the reference distance using the image.

Next, the description will be given about examples of a system to which the image capture device 100 is applied. The image capture device is configured as above and determines whether the object is on the near side or on the deep side of the reference distance (reference position).

### <Automatic Door System>

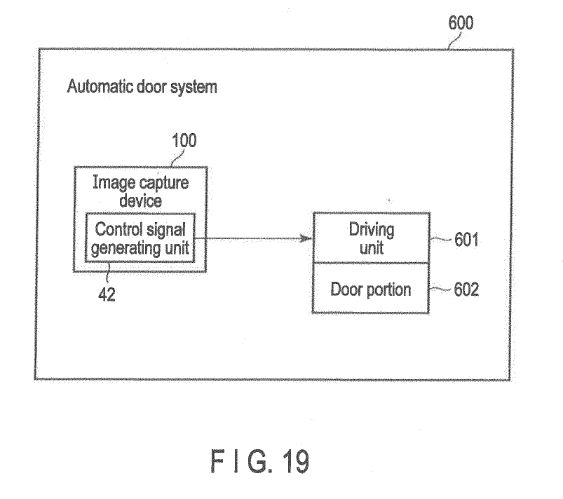

FIG. 19 illustrates a functional configuration of an automatic door system 600 that includes the image capture device 100. As illustrated in FIG. 19, the automatic door system 600 includes the image capture device 100, a driving unit 601 and a door portion 602.

The control signal generating unit 42 in the image capture device 100 generates a control signal related to the opening/closing of the door portion 602 based on the determination result of the determination unit 412, and outputs the generated control signal to the driving unit 601. More specifically, the control signal generating unit 42 generates the control signal to open the door portion 602 based on the determination result indicating that the object is on the near side from the reference distance, and outputs the control signal to the driving unit 601. In addition, the control signal generating unit 42 generates the control signal to close the door portion 602 based on the determination result indicating that the object is on the deep side from the reference distance, and outputs the control signal to the driving unit 601. When the door portion 602 is opened, and the object is positioned on the near side from the reference distance, the control signal generating unit 42 may generate a signal to keep the opening of the door portion 602 and transmit the signal to the driving unit 601. When the door portion 602 is closed, the control signal generating unit 42 may generate a signal to keep the closing of the door portion 602 and transmit the signal to the driving unit 601 according to the relation between the object and the reference distance. When the object moves to the near side from the deep side of the reference distance, the control signal generating unit 42 may generate a signal to open the door portion 602 and transmit the signal to the driving unit 601. When the object moves to the deep side from the near side of the reference distance, the control signal generating unit 42 may generate a signal to close the door portion 602 and transmit the signal to the driving unit 601. The image capture device 100 stores a relation between the object and the reference distance in the storage unit to determine the movement of the object.

The driving unit 601 includes, for example, a motor and opens or closes the door portion 602 by transferring a driving force of the motor to the door portion 602. The driving unit 601 operates the door portion 602 to be opened or closed based on the control signal which is generated by the control signal generating unit 42.

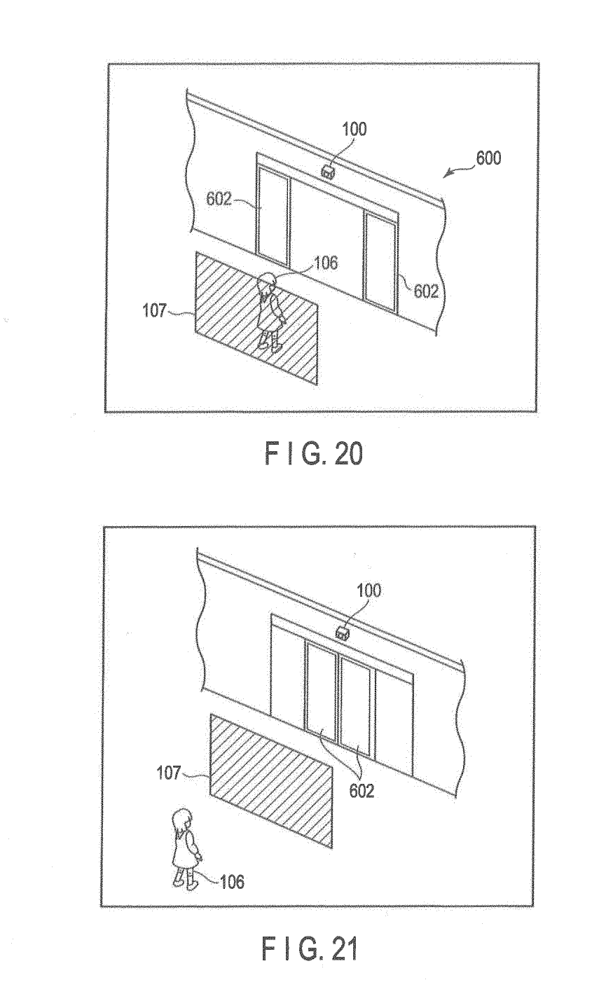

FIGS. 20 and 21 illustrate exemplary operations of the automatic door system 600. In the automatic door system 600, the image capture device 100 is provided on a position for capturing a pedestrian moving in front of the door portion 602, for example, on the upper side of the door portion 602. In other words, the image capture device 100 is provided to acquire an overlooked image of a passage etc., in front of the door portion 602.

The reference distance is not necessary to be equal in all the pixels. For example, a reference surface may be configured by reference distances. The reference surface may be a flat surface, a curved surface or a non-continuous surface. For example, the determination unit 412 of the image capture device 100 determines whether the pedestrian 106 being an object is on the near side or on the deep side from a reference surface 107 using the acquired image. The reference surface 107 is set to be at a certain distance from the door portion 602 in front of the door portion 602 for example. The reference surface 107 is, for example, a flat surface in parallel with the door portion 602. The reference surface 107 and the optical axis of the lens 20 may be perpendicular or may not. The image capture device 100 provided on the upper side of the door portion 602 determines whether the pedestrian 106 is on the near side or on the deep side from the reference surface 107.

Further, the reception unit 43 of the image capture device 100 may receive a designation of a specific object, a specific region or a specific pixel on the acquired image. The reception unit 43 receives, for example, information indicating a pixel contained in the object in front of the door portion 602 designated by the user. The determination unit 412 may determine whether the pixel is on the near side or on the deep side from the reference distance. It is possible to obtain the determination result simply at a high speed by determining some pixels in the image.

In the example illustrated in FIG. 20, the image capture device 100 determines that the pedestrian 106 is on the near side from the reference surface 107. The control signal generating unit 42 generates the control signal to open the door portion 602 based on the determination result, and outputs the signal to the driving unit 601. The driving unit 601 operates to open the door portion 602 based on the control signal received from the control signal generating unit 42. Further, if the door portion 602 is already opened, the driving unit 601 may extend the period where the open state is kept.

In addition, in the example illustrated in FIG. 21, the image capture device 100 determines that the pedestrian 106 is on the deep side from the reference surface 107. The control signal generating unit 42 generates the control signal to close the door portion 602 based on the determination result, and outputs the signal to the driving unit 601. The driving unit 601 operates to close the door portion 602 based on the control signal received from the control signal generating unit 42. Further, if the door portion 602 is already closed, the driving unit 601 may discard the control signal and not perform any other operation.

The determination unit 412 of the image capture device 100 may continuously determine whether the pedestrian (object) 106 is on the near side or on the deep side from the reference surface 107 using continuously captured images. The determination unit 412 can detect that the pedestrian 106 moves from the near side to the deep side of the reference surface 107, or that the pedestrian moves from the deep side to the near side, by using the continuous determination results. Further, the determination unit 412 can detect a time when the pedestrian 106 keeps staying on the near side or on the deep side using the continuous determination results. The determination unit 412 may output a signal containing such a detection result to the control signal generating unit 42.

The control signal generating unit 42 generates the control signal to open the door portion 602 based on the detection result indicating that the pedestrian 106 moves from the deep side to the near side of the reference surface 107, and outputs the control signal to the driving unit 601. In addition, the control signal generating unit 42 generates the control signal to close the door portion 602 based on the detection result indicating that the pedestrian 106 moves from the near side to the deep side of the reference surface 107, and outputs the control signal to the driving unit 601.

Further, based on the detection result indicating a time when the pedestrian 106 keeps staying on the near side of the reference surface 107, the control signal generating unit 42 may estimate that the pedestrian 106 stays on the near side of the door portion 602 and does not pass by the door portion 602 when the time is equal to or more than a threshold. In this case, the control signal generating unit 42 may generate the control signal to close the door portion 602 and output the control signal to the driving unit 601.

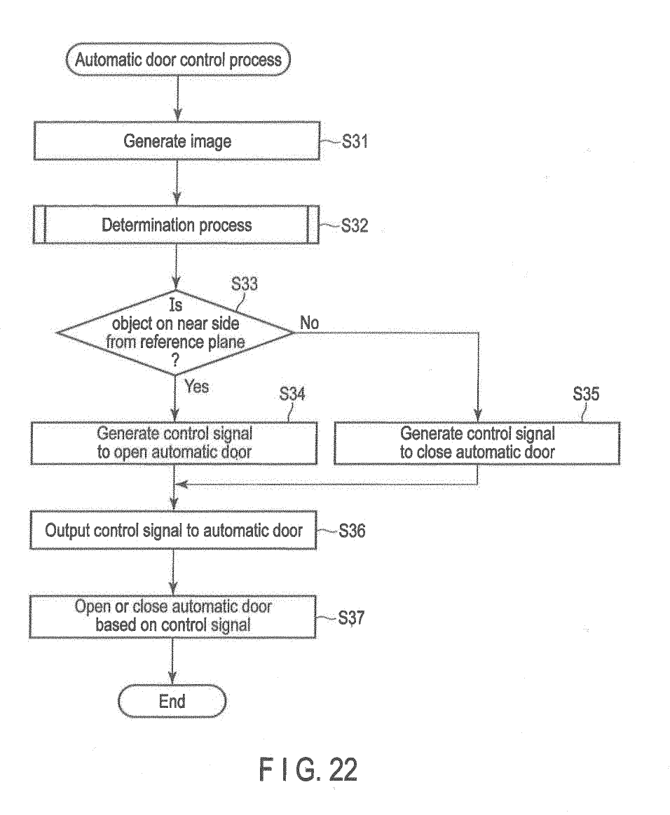

The description will be given with reference to a flowchart of FIG. 22 about an example of the procedure of an automatic door control process executed by the automatic door system 600 including the image capture device 100.

First, the image capture device 100 may generate an ambient image of the door portion 602 (step S31). Then, the image capture device 100 performs the determination process to determine whether the object (for example, a pedestrian) is on the near side or on the deep side from the reference surface using the generated image (step S32).

If the object is on the near side from the reference surface based on the determination process (Yes in step S33), the control signal generating unit 42 generates the control signal to open an automatic door (step S34). On the other hand, if the object is on the deep side from the reference surface (No in step S33), the control signal generating unit 42 generates the control signal to close the automatic door (step S35). Then, the control signal generating unit 42 outputs the control signal to the driving unit 601 (step S36).

The driving unit 601 receives the control signal from the control signal generating unit 42, and operates the door portion 602 to be opened or to be closed based on the received control signal (step S37). In other words, the driving unit 601 receiving the control signal to open the automatic door operates the door portion 602 to be opened. In addition, the driving unit 601 receiving the control signal to close the automatic door operates the door portion 602 to be closed.

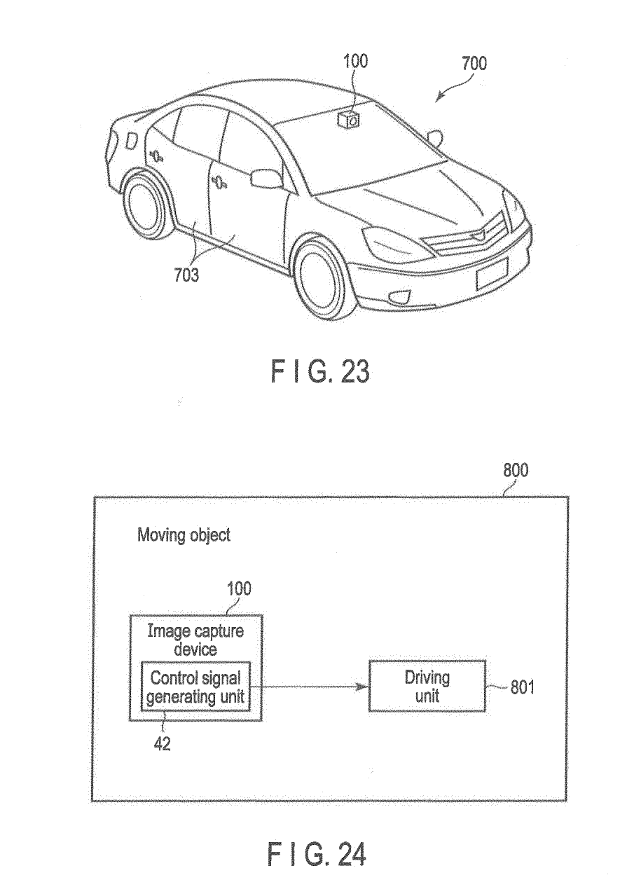

Such a configuration of the automatic door system 600 may also be applied to the control of a door of an automobile. As illustrated in FIG. 23, the image capture device 100 is disposed as a front camera that captures an area ahead of an automobile 700 to acquire the image in an advancing direction of the automobile 700, for example. The image capture device 100 may be disposed as a camera to capture the area ahead from the position of a side-view mirror. The image capture device 100 may be disposed as arear camera to capture the rear area of the automobile 700. A camera may be disposed as the image capture device 100 in place of the side-view mirror to capture the rear area of the automobile 700. Further, the image capture device 100 may be disposed to acquire the image in the outer range of the automobile 700 where the eyes can reach from each door 703 of the automobile 700.

The control signal generating unit 42 generates the control signal related to the opening/closing of the door 703 of the automobile 700 based on the determination result on whether the object is on the near side or on the deep side from the reference distance (or the reference surface) that is output from the determination unit 412 of the image capture device 100. More specifically, when the object is on the near side from the reference distance, the control signal generating unit 42 generates the control signal not to open the door 703 of the automobile 700. Therefore, even when a passenger of the automobile 700 tries to open the door 703 for example, the control is performed not to open the door 703. Therefore, for example, it is possible to prevent an accident that the door 703 conflicts with the object caused by opening the door 703.

When the object is on the deep side from the reference distance, the control signal generating unit 42 generates the control signal to enable the door 703 of the automobile 700 to be opened. Therefore, when the passenger of the automobile 700 operates the door 703 to be opened, the door 703 is controlled to be opened. In other words, when the object is away from the distance where the door comes into contact at the time when the door 703 is opened, the door 703 is opened according to the operation of the passenger of the automobile 700.

### <Moving Object>

FIG. 24 illustrates an example of a functional configuration of a moving object 800 including the image capture device 100. Herein, the moving object 800 includes a robot that autonomously moves such as a moving robot including an automated guided vehicle (AGV), a cleaning robot for cleaning a floor, and a communication robot that provides various guide services to a visitor. The moving object 800 is not limited to such robots, and may be realized as various devices such as a vehicle including the automobile as illustrated in FIG. 23, a flying object including a drone or an airplane, and a ship as long as the device includes a driving unit for movement. The moving object 800 may also include not only the moving robot itself but also an industrial robot that includes a driving unit for movement/rotation of a part of the robot such as a robot arm. Further, the moving object 800 may be an automatic door.

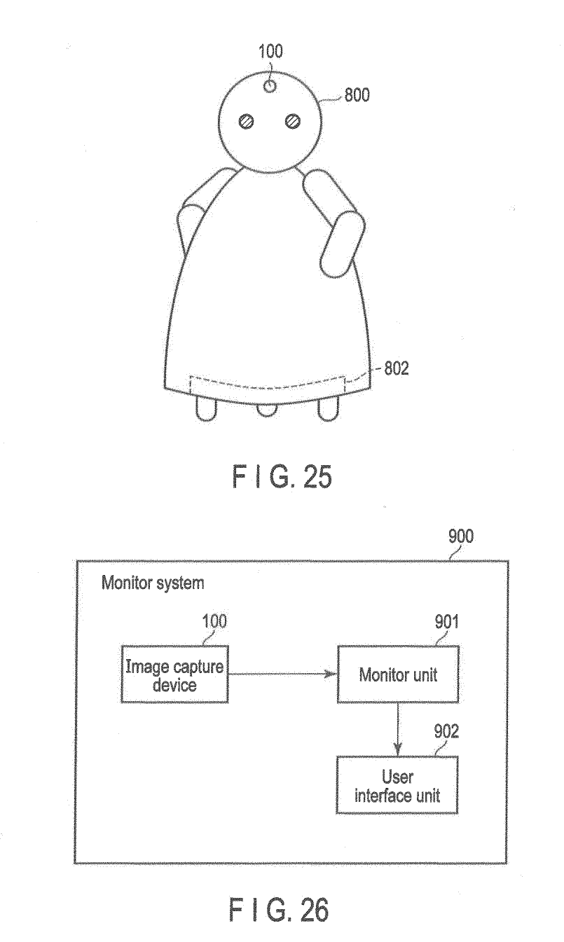

As illustrated in FIG. 24, the moving object 800 includes the image capture device 100 and a driving unit 801. As illustrated in FIG. 25, the image capture device 100 is, for example, provided to capture the object in the advancing direction of the moving object 800 or a part thereof. To capture the object in the advancing direction of the moving object 800, the image capture device 100 may be provided as a so-called front camera that captures the forward area, and also be provided as a so-called rear camera which captures the backward area. Of course, the devices 100 may be provided on both sides. In addition, the image capture device 100 may be provided also to function as a so-called drive recorder. In other words, the image capture device 100 may be the video recording device. Further, when a part of the moving object 800 controls in movement and rotation, the image capture device 100 may be provided at the end of the robot arm to capture an object held in the robot arm for example.

The control signal generating unit 42 in the image capture device 100 generates the control signal related to the movements of the moving object 800 based on the determination result which is output from the image capture device 100 and related on whether the object is on the near side or on the deep side from the reference distance. The control signal relates to an acceleration/deceleration, a level of a lifting force, a turning, a switching between a normal operation mode and an automatic operation mode (conflict avoid mode), and/or an actuation of a safety device such as an air bag of the moving object 800 or a part thereof. More specifically, the control signal generating unit 42 generates the control signal related to at least one of the deceleration, the level of the lifting force, the turning to a direction away from the object, the switching from the normal operation mode to the automatic operation mode (conflict avoid mode), and the actuation of the safety device based on the determination result on that the object is on the near side from the reference distance. The control signal generating unit 42 also generates the control signal related to at least one of the acceleration, the level of the lifting force, the turning to a direction approaching the object, and the switching from the automatic operation mode to the normal operation mode based on the determination result on that the object is on the deep side from the reference distance. The control signal generating unit 42 outputs the generated control signal to the driving unit 801.

The driving unit 801 operates the moving object 800 based on the control signal. That is, the driving unit 801 operates based on the control signal to cause the moving object 800 or a part thereof to perform the acceleration/deceleration, the level of the lifting force, the turning, the switching between the normal operation mode and the automatic operation mode (conflict avoid mode), and/or the actuation of the safety device such as the air bag. As described above, the image capture device 100 can determine whether the object is on the near side or on the deep side from the reference distance at a high speed. Therefore, such a configuration is, for example, applied to the movement of a robot and the automatic operation of the automobile that are necessarily controlled in real time.

As another example, in a case where the moving object 800 is a drone, at the time of inspecting a crack or a wire breaking from the sky, the image capture device 100 acquires an image obtained by capturing an inspection target and determines whether the object is on the near side or on the deep side from the reference distance. The control signal generating unit 42 generates the control signal to control thrust of the drone based on the determination result such that a distance to the inspection target is constant. Herein, the thrust includes the lifting force. The driving unit 801 operates the drone based on the control signal, so that the drone can fly in parallel with the inspection target. In a case where the moving object 800 is a monitoring drone, the control signal may be generated to control the thrust of the drone such that a distance to the object of the monitor target is kept constant.

In addition, at the time when the drone flies, the image capture device 100 acquires an image obtained by capturing the ground and determines whether the ground is on the near side or on the deep side from the reference distance (that is, a height from the ground is smaller or larger than the reference distance). The control signal generating unit 42 generates based on the determination result the control signal to control the thrust of the drone such that the height from the ground becomes a designated height. The driving unit 801 can make the drone to fly at the designated height by operating the drone based on the control signal. In the case of a drone for crop-spraying, the drone can evenly spray agricultural chemicals easily by keeping the height from the ground constant.

Further, in a case where the moving object 800 is the drone or the automobile, at the time of a coordinated flying of the drones or a regimental running of the automobiles, the image capture device 100 acquires an image obtained by capturing a peripheral drone or a preceding automobile and determines whether the drone or the automobile is on the near side or on the deep side from the reference distance. The control signal generating unit 42 generates based on the determination result the control signal to control a thrust of the drone or a speed of the automobile such that a distance to the peripheral drone or the preceding automobile becomes constant. The driving unit 801 operates the drone or the automobile based on the control signal so that the coordinated flying of the drones or the regimental running of the automobiles can be easily performed. In a case where the moving object 800 is the automobile, the reference distance may be configured to be set by a driver by receiving a designation of the driver through a user interface. Therefore, the automobile may run at a desired vehicle-to-vehicle distance of a driver. Alternatively, the reference distance may be changed according to a speed of the automobile to keep a safe vehicle-to-vehicle distance with respect to the preceding automobile. The safe vehicle-to-vehicle distance is different depending on the speed of the automobile. Therefore, the reference distance may be set to be longer as the speed of the automobile is increased. In addition, in a case where the moving object 800 is an automobile, the control signal generating unit 42 may be configured such that a predetermined distance in the advancing direction is set to the reference distance, and when an object appears on the near side of the reference distance, the brake is automatically operated or the safety device such as an air bag is actuated. In this case, the safety device such as an automatic brake and an air bag is provided as the driving unit 801.

### <Monitor System>

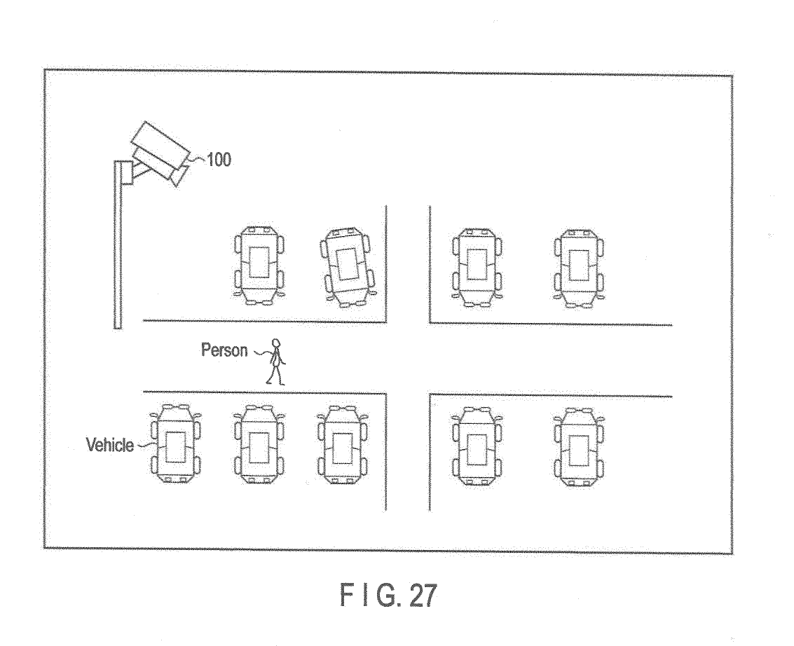

FIG. 26 illustrates a functional configuration of a monitor system 900 including the image capture device 100. Herein, it is assumed that the monitor system 900 is a system to check a flow of people or vehicles in a parking lot every period, for example, as illustrated in FIG. 27. Further, the monitor system 900 is not limited to the parking lot, and may be applied in monitoring various objects that move in a capture range of the image capture device 100 such as a flow of people in a store.

As illustrated in FIG. 26, the monitor system 900 includes the image capture device 100, a monitor unit 901 and a user interface 902. The image capture device 100 and the monitor unit 901 may be connected through a network.

The monitor unit 901 causes the image capture device 100 to capture images continuously, and firstly displays the images captured by the image capture device 100 through the user interface 902. The user interface 302 performs, for example, a display process on a display device, and an input process from a keyboard or a pointing device. The display device and the pointing device may be realized as an integrated device such as a touch screen display for example.

In addition, the monitor unit 301 secondly monitors a state within a capture range of the image capture device 100 based on the determination results that are sequentially output from the image capture device 100 and indicate whether the object is on the near side or on the deep side from the reference distance. The monitor unit 901 analyzes a flow of a person, for example, a flow that a person goes into the reference distance and a flow that a person goes out of the reference distance, or a flow of a vehicle, for example, a flow that a vehicle goes into the reference distance and a flow that a vehicle goes out of the reference distance, and records the analysis result in a storage device such as a hard disk drive (HDD) Further, the analysis may be not necessarily performed in real time, and may be performed as a batch process in which the determination results that are accumulated in the storage device and indicate whether the object is on the near side or on the deep side from the reference distance. In addition, the monitor unit 901 may notify that a person or a vehicle goes into the reference distance, or that a person or a vehicle goes out of the reference distance through the user interface 902.

As described above, according to this embodiment, it is possible to determine the position of the object with respect to the reference position at a high speed. Therefore, the determination result on whether the object is on the near side or on the deep side of the reference position can be obtained in real time, so that it is possible to realize a system that appropriately controls various types of apparatuses in an environment where a positional relation with respect to the object is dynamically changed.

Further, each of various functions described in any of the embodiments may be realized by a circuit (processing circuit). Examples of the processing circuit include a programmed processor such as a central processing unit (CPU). This processor performs each described function by executing a computer program (instructions) stored in a memory. This processor may be a microprocessor including an electric circuit. Examples of a processing circuit include a digital signal processor (DSP), an application specific integrated circuit (ASIC), a microcontroller, a controller, and other electric circuit components. Each of components other than the CPU described in the embodiments may be realized by a processing circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing device comprising:
a memory; and
a circuit coupled with the memory;
wherein the circuit is configured to:
acquire a first image of a first color component and a second image of a second color component, the first image having a non-point-symmetric blur function and capturing a first object, the second image having a point-symmetric blur function and capturing the first object; and
determine whether the first object is on a near side of a first position or on a deep side of the first position when viewed from a capture position based on the first image and the second image.

2. The processing device of claim 1,
wherein the circuit is configured to determine whether the first object is on the near side of the first position or on the deep side of the first position based on a blur shape of the first image and a blur shape of the second image.

3. The processing device of claim 1,
wherein the circuit is further configured to:
generate a control signal to control an external device based on a determination result indicating that the first object is on the near side or on the deep side of the first position; and
output the generated control signal to the external device.

4. The processing device of claim 3,
wherein the external device comprises an automatic door, and
wherein the control signal comprises a control signal related to opening or closing of the automatic door.

5. The processing device of claim 4,
wherein the circuit is configured to:
generate a control signal to open the automatic door if it is determined that the first object is on the near side of the first position; and
generate a control signal to close the automatic door if it is determined that the first object is on the deep side of the first position.

6. The processing device of claim 3,
wherein the external device comprises an automobile, and
wherein the control signal comprises a control signal related to opening or closing of a door of the automobile.

7. The processing device of claim 6,
wherein the circuit is configured to:
generate a control signal to open the door if it is determined that the first object is on the near side of the first position; and
generate a control signal to close the door if it is determined that the first object is on the deep side of the first position.

8. The processing device of claim 3,
wherein the external device comprises a moving object, and
wherein the control signal comprises a control signal related to an acceleration, a deceleration, a level of a lifting force, a turning, a switching between a normal operation mode and an automatic operation mode, and/or an actuation of a safety device of the moving object.

9. The processing device of claim 1, further comprising:
a receiver configured to receive information to designate one or more target pixels on the image,
wherein the circuit is configured to determine whether the first object comprising the one or more target pixels is on the near side of the first position or on the deep side of the first position when viewed from the capture position.

10. The processing device of claim 1,
wherein the circuit is further configured to:
detect an event based on a determination result indicating that the first object is on the near side or on the deep side of the first position; and
generate attribute information associated with the image based on the event.

11. An image capture device comprising:
a memory;
a circuit coupled with the memory; and
an image capture unit configured to capture a first image of a first color component and a second image of a second color component, the first image having a non-point-symmetric blur function and capturing a first object, the second image having a point-symmetric blur function and capturing the first object,
wherein the circuit is configured to determine whether the first object is on a near side of a first position or on a deep side of the first position when viewed from a capture position based on the first image and the second image.

12. The image capture device of claim 11,
wherein the circuit is further configured to generate a control signal to change a focus distance of the image capture unit based on a determination result indicating that the first object is on the near side or on the deep side of the first position.

13. The image capture device of claim 11,
wherein the circuit is further configured to generate a control signal to zoom in or out the first object based on a determination result indicating that the first object is on the near side or on the deep side of the first position.

14. An automatic control system comprising:
a moving object;
a memory; and
a circuit coupled with the memory;
wherein the circuit is configured to:
acquire a first image of a first color component and a second image of a second color component, the first image having a non-point-symmetric blur function and capturing a first object, the second image having a point-symmetric blur function, and capturing the first object;
determine whether the first object is on a near side of a first position or on a deep side of the first position when viewed from a capture position based on the first image and the second image; and
generate a control signal to control a movement of the moving object based on a determination result indicating that the first object is on the near side or on the deep side of the first position.

15. The automatic control system of claim 14, further comprising
an image capture unit configured to capture the first image and the second image.
